(19) United States
(12) Patent Application Publication
(10) Pub. No.: US 2025/0088613 A1
(43) Pub. Date: Mar. 13, 2025

(54) PROJECTION APPARATUS AND DISPLAY METHOD THEREOF, STORAGE MEDIUM

(71) Applicant: Hisense Laser Display Co., Ltd, Qingdao City (CN)

(72) Inventors: Xing Chen, Qingdao City (CN); Jichen Xiao, Qingdao City (CN); Xu Chen, Qingdao City (CN)

(73) Assignee: Hisense Laser Display Co., Ltd, Qingdao City (CN)

(21) Appl. No.: 18/961,159

(22) Filed: Nov. 26, 2024

Related U.S. Application Data
(63) Continuation of application No. PCT/CN2023/097493, filed on May 31, 2023.

(30) Foreign Application Priority Data
Jun. 1, 2022 (CN) 202210622937.7
Jun. 1, 2022 (CN) 202210623034.0

(51) Int. Cl. H04N 9/31

(52) U.S. Cl. CPC H04N 9/3182; H04N 9/3152; H04N 9/3161

(57) ABSTRACT

A projection apparatus, a display method of a projection apparatus, and a storage medium are provided. The projection apparatus includes a light valve, a first controller, and a second controller. The light valve is configured to modulate incident beams. The first controller is configured to receive and output image data. The output image data includes at least one of first data or second data. The second controller is configured to receive and process the image data. The first controller is further configured to perform color gamut conversion on the first data and not perform color gamut conversion on the second data. The second controller is further configured to perform color gamut conversion on the second data, so as to make a color gamut of a second image be same as a color gamut of a first image.

### CROSS-REFERENCE TO RELATED APPLICATIONS

### Cross-Reference to Related Applications

This application is a by-pass continuation application under 35 U.S.C. § 1.11 (a) of International Patent Application No. PCT/CN2023/097493, filed on May 31, 2023, which claims priority to Chinese Patent Application No. 202210623034.0, filed on Jun. 1, 2022; and Chinese Patent Application No. 202210622937.7, filed on Jun. 1, 2022, which are incorporated herein by reference in their entireties.

### TECHNICAL FIELD

The present disclosure relates to the field of projection display technologies and, in particular, to a projection apparatus, a display method of a projection apparatus, and a storage medium.

### BACKGROUND

With the continuous development of projection display technologies, projection apparatuses are becoming increasingly popular with consumers. Since the laser beam has characteristics such as good monochrome and high luminance, the projection apparatus usually uses the laser beam as a laser source to display the projection image.

### SUMMARY

In an aspect, a projection apparatus is provided. The projection apparatus includes a light valve, a first controller, and a second controller. The light valve is configured to modulate incident beams according to a driving signal, so as to obtain projection beams. The projection beams are incident on a projection lens to project an image to be displayed. The image to be displayed is an entire image required to be displayed by the projection apparatus and includes at least one of a first image or a second image. The first controller is configured to receive image data and output the image data. The output image data includes at least one of first data or second data. The first data is used for displaying the first image, and the second data is used for displaying the second image. The second controller is connected to the first controller and the light valve and configured to receive the image data output by the first controller and process the output image data to generate the driving signal, so as to drive the light valve to modulate the incident beams. The first controller is further configured to perform color gamut conversion on the first data and not perform color gamut conversion on the second data. The second controller is further configured to perform color gamut conversion on the second data, so as to make a color gamut of the second image be same as a color gamut of the first image.

In another aspect, a display method of a projection apparatus is provided. The display method is applied to the projection apparatus. The projection apparatus includes a first controller, a second controller, and a light valve. The light valve is configured to modulate incident beams according to a driving signal, so as to obtain projection beams. The projection beams are incident on a projection lens to project an image to be displayed. The image to be displayed is an entire image required to be displayed by the projection apparatus and includes at least one of a first image or a second image. The second controller is connected to the first controller and the light valve. The method includes: receiving image data and outputting the image data by the first controller, the output image data including at least one of first data or second data, the first data being used for displaying the first image, and the second data being used for displaying the second image; and receiving the image data output by the first controller and processing the output image data to generate the driving signal, by the second controller, so as to drive the light valve to modulate the incident beams. The method further includes: performing color gamut conversion on the first data and not performing color gamut conversion on the second data by the first controller; and performing color gamut conversion on the second data by the second controller, so as to make a color gamut of the second image be same as a color gamut of the first image.

In yet another aspect, a projection apparatus is provided. The projection apparatus includes a light valve, a first controller, and a second controller. The light valve is configured to modulate incident beams according to a driving signal, so as to obtain projection beams. The first controller is configured to perform color gamut conversion on first data by using a color gamut of a current image mode and not perform color gamut conversion on second data. The second controller is connected to the first controller and the light valve and configured to receive image data output by the first controller and process the output image data to generate the driving signal, so as to drive the light valve to modulate the incident beams. The image data output by the first controller includes at least one of the first data or the second data. The first data is used for displaying a first image, and the second data is used for displaying a second image. The first controller is configured to: receive image data; determine a color gamut corresponding to a current image mode of the projection apparatus as a target color gamut, and send information related to the target color gamut and the image data to the second controller, if the first data and the second data are simultaneously identified in a same frame of image data to be displayed. The second controller is further configured to process the second data by using the target color gamut, and generate the driving signal according to the first data and the second data, in response to the information related to the target color gamut.

In yet another aspect, a display method of a projection apparatus is provided. The method is executed by the projection apparatus.

In yet another aspect, a non-transitory computer-readable storage medium is provided. The non-transitory computer-readable storage medium has stored computer program instructions. When the computer program instructions run on a computer, the computer program instructions make the computer to perform one or more steps in the display method.

### BRIEF DESCRIPTION OF THE DRAWINGS

FIG. 1 is a diagram showing a structure of a projection system, in accordance with some embodiments;

FIG. 2 is a diagram showing a structure of a projection apparatus, in accordance with some embodiments;

FIG. 3 is a diagram showing a beam path of a laser source, a light modulation assembly, and a projection lens in a projection apparatus, in accordance with some embodiments;

FIG. 4 is a diagram showing a principle of projection imaging by a projection apparatus, in accordance with some embodiments;

FIG. 5 is a diagram showing an arrangement of micromirrors in a digital micromirror device, in accordance with some embodiments;

FIG. 6 is a chromaticity diagram of a projection apparatus, in accordance with some embodiments;

FIG. 7 is a diagram showing another structure of a projection apparatus, in accordance with some embodiments;

FIG. 8 is a schematic diagram of a first image displayed by a projection apparatus, in accordance with some embodiments;

FIG. 9 is a schematic diagram of a second interface, in accordance with some embodiments;

FIG. 10 is a schematic diagram of a first image and a second image displayed simultaneously by a projection apparatus, in accordance with some embodiments;

FIG. 11 is another schematic diagram of a first image and a second image displayed simultaneously by a projection apparatus, in accordance with some embodiments;

FIG. 12 is another schematic diagram of a second interface, in accordance with some embodiments;

FIG. 13 is yet another schematic diagram of a first image and a second image displayed simultaneously by a projection apparatus, in accordance with some embodiments;

FIG. 14 is a flow chart of a display method of a projection apparatus, in accordance with some embodiments;

FIG. 15 is another flow chart of a display method of a projection apparatus, in accordance with some embodiments;

FIG. 16 is yet another flow chart of a display method of a projection apparatus, in accordance with some embodiments;

FIG. 17 is yet another flow chart of a display method of a projection apparatus, in accordance with some embodiments;

FIG. 18 is yet another flow chart of a display method of a projection apparatus, in accordance with some embodiments;

FIG. 19 is yet another flow chart of a display method of a projection apparatus, in accordance with some embodiments;

FIG. 20 is a schematic diagram of a remote control device, in accordance with some embodiments;

FIG. 21 is yet another flow chart of a display method of a projection apparatus, in accordance with some embodiments;

FIG. 22 is yet another flow chart of a display method of a projection apparatus, in accordance with some embodiments;

FIG. 23 is yet another flow chart of a display method of a projection apparatus, in accordance with some embodiments;

FIG. 24 is yet another flow chart of a display method of a projection apparatus, in accordance with some embodiments;

FIG. 25 is yet another flow chart of a display method of a projection apparatus, in accordance with some embodiments;

FIG. 26 is another schematic diagram of a remote control device, in accordance with some embodiments;

FIG. 27 is yet another flow chart of a display method of a projection apparatus, in accordance with some embodiments; and

FIG. 28 is yet another flow chart of a display method of a projection apparatus, in accordance with some embodiments.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected” and derivatives thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “A and/or B” includes the following three combinations: only A, only B, and a combination of A and B.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

As used herein, the term “if” is, optionally, construed as “when” or “in a case where” or “in response to determining that” or “in response to detecting,” depending on the context. Similarly, depending on the context, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event].”

The use of the phrase “applicable to” or “configured to” herein means an open and inclusive expression, which does not exclude devices that are applicable to or configured to perform additional tasks or steps.

A projection system 1 is provided in some embodiments of the present disclosure.

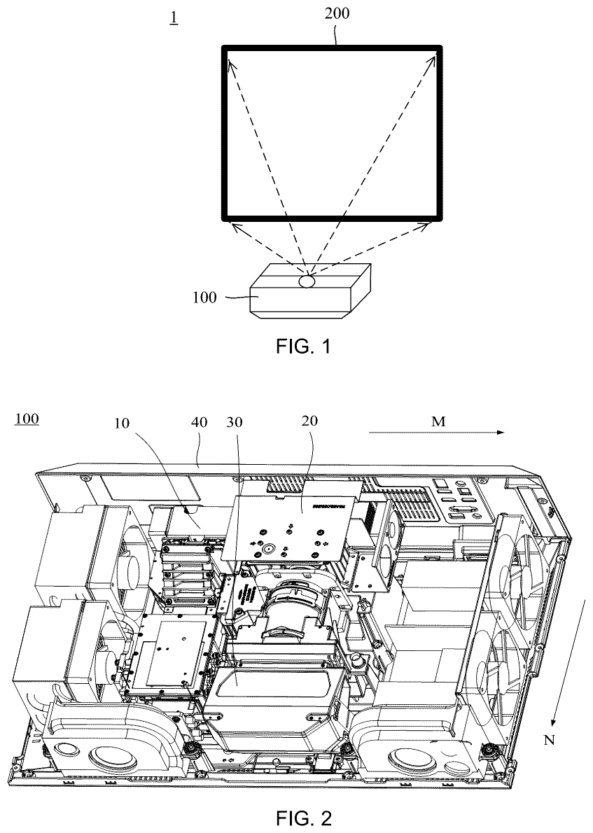

FIG. 1 is a diagram showing a structure of a projection system, in accordance with some embodiments.

In some embodiments, as shown in FIG. 1, the projection system 1 includes a projection apparatus 100 and a projection screen 200.

FIG. 2 is a diagram showing a structure of a projection apparatus, in accordance with some embodiments.

As shown in FIG. 2, the projection apparatus 100 includes an apparatus housing 40 (only a portion of the apparatus housing 40 being shown in FIG. 2), and a laser source 10, a light modulation assembly 20, and a projection lens 30 that are assembled in the apparatus housing 40. The laser source 10 is configured to provide illumination beams (e.g., laser beams). The light modulation assembly 20 is configured to modulate the illumination beams provided by the laser source 10 with image signals, so as to obtain projection beams. The projection lens 30 is configured to project the projection beams into an image on a screen or a wall.

The laser source 10, the light modulation assembly 20, and the projection lens 30 are sequentially connected in a propagation direction of beams, and each is wrapped by a corresponding housing. The housings of the laser source 10, the light modulation assembly 20, and the projection lens 30 support their corresponding optical components, respectively, and make the optical components meet certain sealing or airtight requirements.

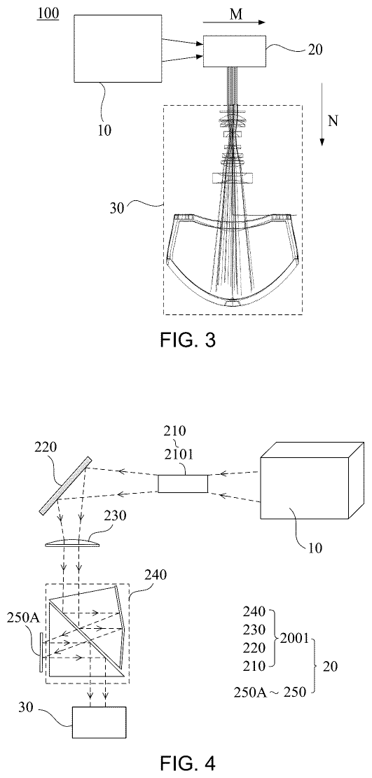

FIG. 3 is a diagram showing a beam path of a laser source, a light modulation assembly, and a projection lens in a projection apparatus, in accordance with some embodiments.

As shown in FIG. 3, a first end of the light modulation assembly 20 is connected to the laser source 10, and the laser source 10 and the light modulation assembly 20 are arranged in an exit direction (referring to the direction M shown in FIG. 3) of the illumination beams of the projection apparatus 100. A second end of the light modulation assembly 20 is connected to the projection lens 30, and the light modulation assembly 20 and the projection lens 30 are arranged in an exit direction (referring to the direction N shown in FIG. 3) of the projection beams of the projection apparatus 100. The exit direction M of the illumination beams is substantially perpendicular to the exit direction N of the projection beams. In one aspect, such connecting structure may adapt to characteristics of a beam path of a reflective light valve in the light modulation assembly 20, and in another aspect, it is also conducive to shortening a length of a beam path in a one-dimensional direction, which is helpful for structural arrangement of the apparatus. For example, in a case where the laser source 10, the light modulation assembly 20, and the projection lens 30 are disposed in a one-dimensional direction (e.g., the direction M), the length of the beam path in the one-dimensional direction is long, which is not conducive to the structural arrangement of the apparatus. The reflective light valve will be described below.

In some embodiments, the laser source 10 may sequentially provide beams of three primary colors (beams of other colors may also be added on a basis of the beams of the three primary colors). Due to a phenomenon of visual perception of human eyes, what the human eyes see is white beams formed by mixing the beams of three primary colors. Alternatively, the laser source 10 may also simultaneously output the beams of three primary colors, so as to continuously emit the white beams.

In some embodiments, the laser source 10 includes a laser device. Since the laser beam emitted by the laser device has characteristics of good monochrome, high color purity, high luminance, and good direction, the laser device is widely used as the laser source of the projection apparatus 100.

It will be noted that the projection apparatus 100 with the laser device as the laser source 10 may be referred to as a laser projection apparatus. In a case where the laser projection apparatus uses a red laser device, a green laser device, and a blue laser device as the laser source, the red laser device emits a red laser beam, the green laser device emits a green laser beam, and the blue laser device emits a blue laser beam. The laser projection apparatus achieves the display of an image through the laser beams of three colors, so that the laser projection apparatus may obtain a large color gamut and have a good color performance.

FIG. 4 is a diagram showing a principle of projection imaging by a projection apparatus, in accordance with some embodiments.

The illumination beams emitted by the laser source 10 enter the light modulation assembly 20. As shown in FIG. 4, the light modulation assembly 20 includes an illumination lens group 2001 and a light modulation device (or a light valve) 250. The illumination lens group 2001 is configured to receive the illumination beams provided by the laser source 10 and propagate the illumination beams to the light modulation device 250 at a set angle and direction. The light modulation device 250 is configured to modulate the illumination beams to obtain the projection beams and reflect the projection beams into the projection lens 30.

In some embodiments, as shown in FIG. 4, the illumination lens group 2001 includes a homogenizing component 210, a lens group 230, and a prism group 240. The homogenizing component 210 is configured to receive the illumination beams provided by the laser source 10 and homogenize the illumination beams. The lens group 230 is configured to converge the illumination beams exiting from the homogenizing component 210 onto the prism group 240. The prism group 240 is configured to reflect the illumination beams to the light modulation device 250.

In some embodiments, as shown in FIG. 4, the homogenizing component 210 includes a light pipe 2101. A light outlet of the light pipe 2101 may be in a shape of a rectangle, so as to have a shaping effect on a beam spot. In this way, the shape of the beam spot of the illumination beams exiting from the light pipe 2101 may match a rectangular laser-receiving surface of the light modulation device 250. Alternatively, the homogenizing component 210 may include a fly-eye lens. The fly-eye lens may homogenize the incident illumination beams and shape the illumination beams, so as to output a rectangular beam spot.

In the light modulation assembly 20, the light valve 250 is configured to use an image signal (e.g., a driving signal generated according to an image to be displayed) to modulate the illumination beams provided by the laser source 10. That is to say, the light valve 250 controls the projection beams to display different luminance and gray scales according to different pixels in an image to be displayed, so as to finally produce an optical image. Depending on whether the light valve 250 transmits or reflects the illumination beams, the light modulation device may be classified as a transmissive light modulation device or a reflective light modulation device. For example, the digital micromirror device (DMD) 250A shown in FIG. 4 reflects the illumination beams, and thus it is the reflective light modulation device. A liquid crystal light valve transmits the illumination beams, and thus it is the transmissive light modulation device. In addition, the light modulation assembly 20 may be classified as a single-chip system, a double-chip system, or a three-chip system according to the number of the light modulation devices used in the light modulation assembly 20. The light valve 250 in some embodiments of the present disclosure is the digital micromirror device 250A.

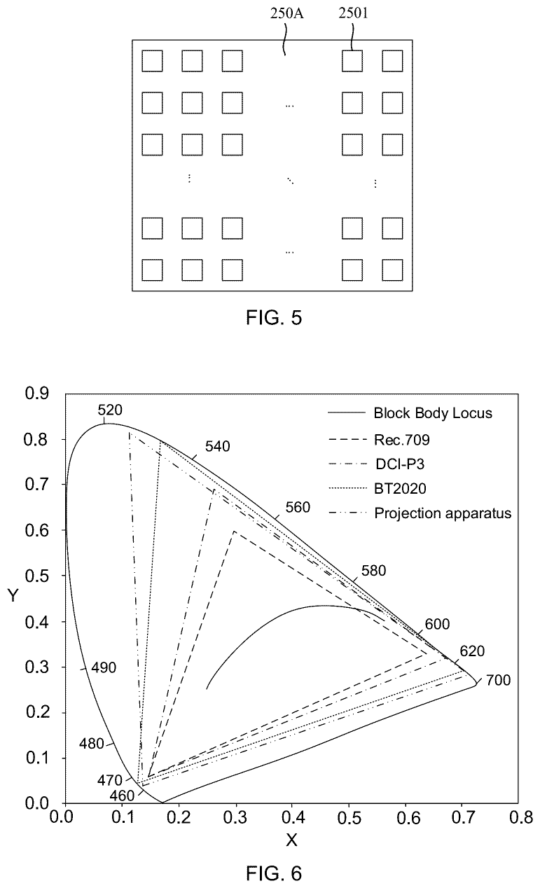

FIG. 5 is a diagram showing an arrangement of micromirrors in a digital micromirror device, in accordance with some embodiments.

As shown in FIG. 5, the digital micromirror device 250A includes thousands of micromirrors 2501 that may be individually driven to rotate. These micromirrors 2501 are arranged in an array. One micromirror 2501 (e.g., each micromirror 2501) corresponds to one pixel in the projection image to be displayed. The image signals may be converted into digital codes such as 0 or 1 after being processed. The micromirrors 2501 may swing in response to these digital codes. The gray scale of each pixel in a frame of an image is achieved by controlling durations of each micromirror 2501 in an ON state and an OFF state. In this way, the digital micromirror device 250A may modulate the illumination beams, thereby displaying the projection image. The ON state of the micromirror 2501 is a state that the micromirror 2501 is in and may be maintained when the illumination beams emitted by the laser source 10 may enter the projection lens 30 after being reflected by the micromirror 2501. The OFF state of the micromirror 2501 is a state that the micromirror 2501 is in and may be maintained when the illumination beams emitted by the laser source 10 do not enter the projection lens 30 after being reflected by the micromirror 2501.

The homogenizing component 210, the reflecting lens 220, and the lens group 230 at a front end of the DMD 250A form an illumination path, and the illumination beams emitted by the laser source 10 have a beam size and an incident angle meeting the requirement of the DMD 250A after passing through the illumination path.

The projection apparatus 100 and the projection screen 200 are arranged at an interval, and the projection screen 200 is configured to receive the projection beams exiting from the projection apparatus 100 for displaying an image. For example, the projection screen 200 is a screen, a wall, a front windshield of a car, or a window of a showcase, and the present disclosure is not limited thereto.

The following is described by considering an example in which the projection apparatus 100 includes the laser projection apparatus, the laser projection apparatus uses the red laser device, the green laser device, and the blue laser device as the laser source 10, and the light valve in the laser projection apparatus uses the DMD.

FIG. 6 is a chromaticity diagram of a projection apparatus, in accordance with some embodiments.

In a case where the projection apparatus 100 uses the three-color laser device as the laser source 10, when the projection apparatus 100 displays an image, the color gamut that the projection apparatus 100 may display is related to wavelengths of the red laser beam, the green laser beam, and the blue laser beam emitted by the laser source 10. A full width at half maxima (FWHM) of the wavelength of the laser beam emitted by the laser device is narrow, and the laser beam has high color purity. Therefore, as shown in FIG. 6, the color gamut (e.g., the area of the triangle surrounded by the dotted line corresponding to the projection apparatus 100 in FIG. 6) of the image displayed by the projection apparatus 100 is greater than the maximum color gamut limited by the color gamut standard (e.g., the area of the triangle surrounded by the dotted line corresponding to BT2020 in FIG. 6). In this way, the image displayed by the projection apparatus 100 may meet the demand of users for an image with a large color gamut.

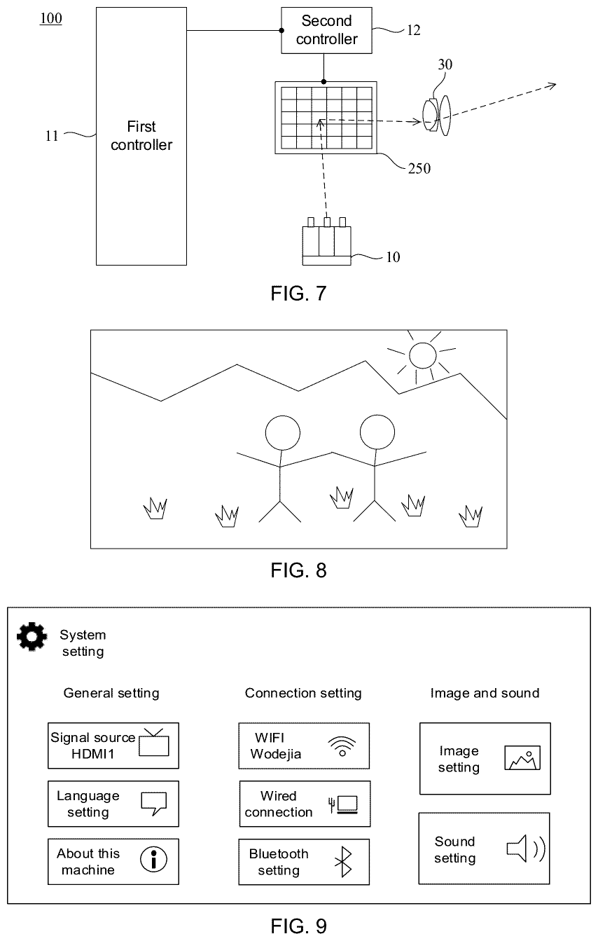

FIG. 7 is a diagram showing another structure of a projection apparatus, in accordance with some embodiments.

In some embodiments, as shown in FIG. 7, the projection apparatus 100 further includes a first controller 11 and a second controller 12.

The light valve 250 is located on a laser-exit side of the laser source 10, and the projection lens 30 is located on a beam path of the projection beams exiting from the light valve 250, so as to project the projection beams into an image. The first controller 11 is connected to the second controller 12, and the first controller 11 is configured to process the image data and send the image data and corresponding instruction to the second controller 12. The second controller 12 is connected to the light valve 250 and configured to: receive the image data output by the first controller 11, and process the output image data, so as to generate the driving signal to drive the light valve 250 to modulate the incident beams, thereby achieving image display.

The first controller 11 may be a system on chip (SOC) in the projection apparatus 100. The second controller 12 may be a chip in the digital light processing (DLP) system, which is used to control the light valve 250. For example, the second controller 12 is a master control chip of a display board.

When the projection apparatus 100 displays an image, the first controller 11 receives the image data and decodes the received image data. For example, the first controller 11 decodes the received image data into the low-voltage differential signaling (LVDS). The first controller 11 sends the decoded image data to the second controller 12, the second controller 12 receives the decoded image data and processes the decoded image data into a driving signal, and drives the light valve 250 to modulate the incident beams according to the driving signal, so as to achieve the image display.

The first controller 11 has a color gamut converting function. For example, the first controller 11 performs color gamut conversion according to a current image mode in the projection apparatus 100 after receiving the image data. For example, in a case where the current image mode in the projection apparatus 100 is a first image mode, the first controller 11 converts the color gamut of the image to be displayed into a color gamut corresponding to the first image mode after receiving the image data. In a case where the current image mode in the projection apparatus 100 is a second image mode, the first controller 11 converts the color gamut of the image to be displayed into a color gamut corresponding to the second image mode after receiving the image data. The first image mode and the second image mode will be described below.

The image (i.e., an image to be displayed) displayed by the projection apparatus 100 includes at least one of a first image or a second image. The first image refers to a multimedia image, and the second image refers to a menu image.

The image data output by the first controller 11 to the second controller 12 includes at least one of first data or second data. The first data refers to multimedia data used for displaying the first image. For example, the first data includes high definition multimedia interface (HDMI) video data. The first data may be input to the first controller 11 by means of a network, antenna, closed-circuit television, memory card, etc. The second data is menu data used for displaying the second image. The second data may be generated by an image generator (e.g., a graphics processing unit (GPU)) in the projection apparatus 100.

However, the first controller 11 performs color gamut conversion only on the first data, and may not perform the color gamut conversion on the second data. In this case, the projection apparatus 100 displays the second image by using a preset color gamut in the projection apparatus 100. The preset color gamut in the projection apparatus 100 may be a color gamut satisfying a BT2020 standard or an own color gamut of the projection apparatus 100, etc. It will be noted that in a case where the projection apparatus 100 is provided with a plurality of color gamut, the preset color gamut in the projection apparatus 100 is the maximum color gamut.

In some embodiments, there are a plurality of image modes in the projection apparatus 100. For example, the plurality of image modes include a first image mode and a second image mode. A color gamut corresponding to the first image mode is a first preset color gamut. A color gamut corresponding to the second image mode is a second preset color gamut. The first preset color gamut is less than or equal to the second preset color gamut. In a case where the first preset color gamut is less than the second preset color gamut, the image displayed by the projection apparatus 100 by using the second preset color gamut may be more vivid than the image displayed by the projection apparatus 100 by using the first preset color gamut. Thus, the first image mode is also referred to as a standard image mode, and the second image mode is also referred to as a vivid image mode.

For example, the first preset color gamut satisfies an Rec.709 standard or a DCI-P3 standard. The second preset color gamut satisfies the BT2020 standard, or, the second preset color gamut is the own color gamut of the projection apparatus 100.

Here, the first preset color gamut is less than the second preset color gamut, which may mean that, a range of the first preset color gamut is within a range of the second preset color gamut in the chromaticity diagram.

It will be noted that the projection apparatus 100 displays the first image through the first image mode by default, and the user may select different image modes in a process of displaying the first image. In addition, since the second image is signals generated by the projection apparatus 100, the projection apparatus 100 uses the preset color gamut in the projection apparatus 100 to display the second image by default.

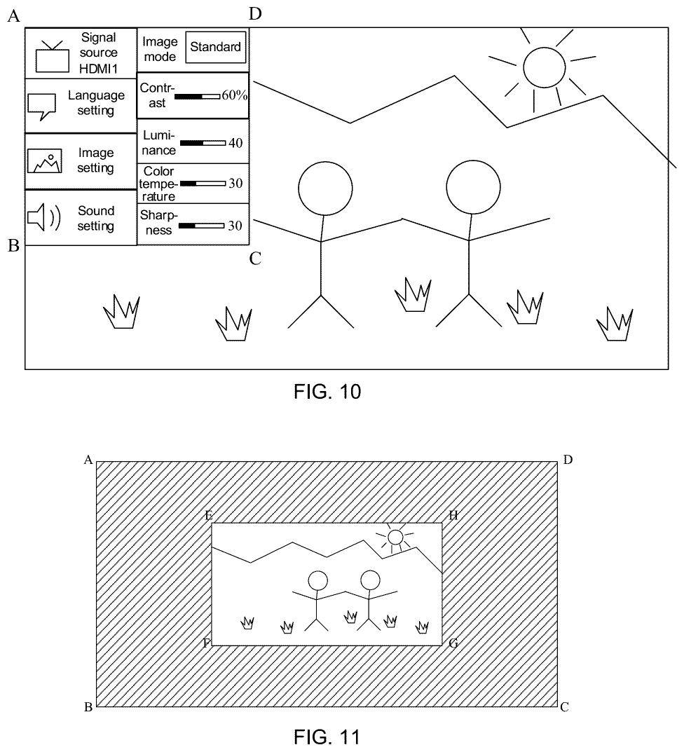

FIG. 8 is a schematic diagram of a first image displayed by a projection apparatus, in accordance with some embodiments. FIG. 9 is a schematic diagram of a second interface, in accordance with some embodiments. FIG. 10 is a schematic diagram of a first image and a second image displayed simultaneously by a projection apparatus, in accordance with some embodiments.

In some embodiments, the image displayed by the projection apparatus 100 includes at least one of a first interface or a second interface. The first interface serves as a region for displaying the first image. The second interface serves as a region for displaying the second image. For example, when the user is watching films and television programs, as shown in FIG. 8, the entire image displayed by the projection apparatus 100 serves as the first interface to display the first image.

In some embodiments, as shown in FIG. 9, the second interface is configured to display a setting interface of system parameters of the projection apparatus 100. For example, when the user watches films and television programs, the user needs to set the system parameters of the projection apparatus 100, and the user may send an instruction to find out the second interface through an external device. The second interface may be displayed at the same time as the first interface, and the second interface displays parameter information of the projection apparatus 100, so that the user may set the system parameters when watching the first image. The system parameters may include the size, resolution, luminance, contrast, and signal source of the displayed image.

For example, as shown in FIG. 10, in a case where the projection apparatus 100 displays the first image (i.e., the image displayed in the region outside the rectangular region surrounded by vertices A, B, C, and D in FIG. 10), a portion (i.e., the rectangular region surrounded by vertices A, B, C, and D in FIG. 10) of the displayed image may be the second image. Here, the rectangular region surrounded by vertices A, B, C, and D in FIG. 10 is the second interface, and the region outside the rectangular region surrounded by vertices A, B, C, and D in FIG. 10 is the first interface.

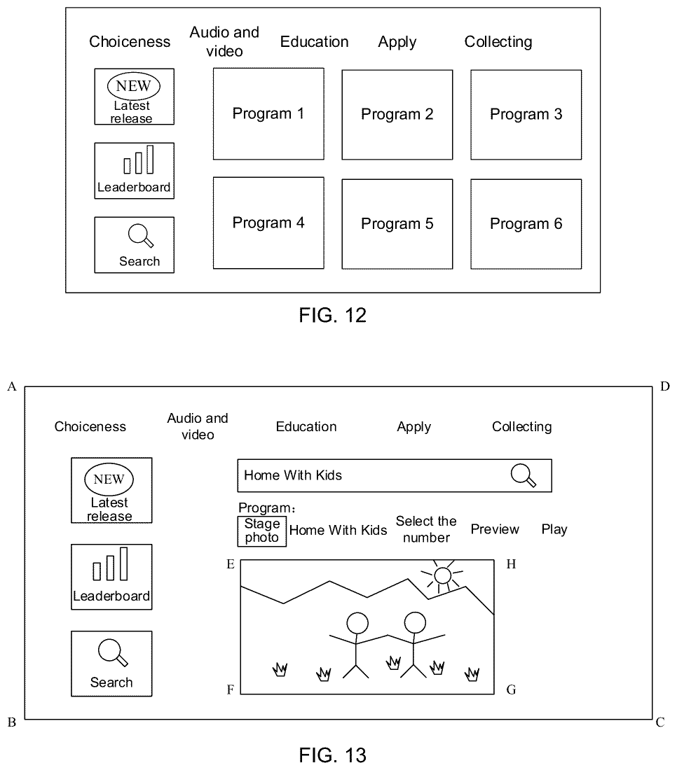

FIG. 11 is another schematic diagram of a first image and a second image displayed simultaneously by a projection apparatus, in accordance with some embodiments. FIG. 12 is another schematic diagram of a second interface, in accordance with some embodiments. FIG. 13 is yet another schematic diagram of a first image and a second image displayed simultaneously by a projection apparatus, in accordance with some embodiments.

In some embodiments, the second interface may be configured to display a background image while the first image is being displayed. For example, as shown in FIG. 11, in a case where the user watches films and television programs in full screen, the user sends a first exiting instruction through the external device, so as to exit the full-screen display, and the second image may fill a background region (i.e., the region outside the rectangular region surrounded by vertices E, F, G, and H in FIG. 11) that appears after the first image exits the full-screen display, so as to serve as the background of the first image (i.e., the image displayed in the rectangular region surrounded by vertices E, F, G, and H in FIG. 11).

In some embodiments, the second interface may be configured to display a main menu interface. As shown in FIG. 12, films and television programs and other information are displayed in the main menu interface, and the user may select movies and television series they want to watch, or search for films and television programs they want to watch. When finding the corresponding film and television program, the user may send a preview instruction through the external device, so as to preview the content of film and television program in a form of displaying in a small window, and the user may continue to look for other programs in the main menu interface during the preview process.

As shown in FIG. 13, in a case where the projection apparatus 100 displays the second image (i.e., the image displayed in the region outside the rectangular region surrounded by vertices E, F, G, and H in FIG. 13), the projection apparatus 100 may also display the first image in the first interface (i.e., the image displayed in the rectangular region surrounded by vertices E, F, G, and H in FIG. 13).

It will be noted that FIGS. 9 and 12 illustrate by considering an example in which the displayed image is the second image.

The above description is given by considering an example in which the projection apparatus 100 displays the first image and the second image simultaneously and displays the second image in various scenes. Of course, the projection apparatus 100 may also display the first image and the second image simultaneously in other conditions, or the projection apparatus 100 may display the first image or the second image separately, and the present disclosure is not limited thereto.

The first controller 11 converts only the color gamut of the first data and may not convert the color gamut of the second data, and the projection apparatus 100 uses the preset color gamut in the projection apparatus 100 to display the second image by default due to the second data generated by the projection apparatus 100 itself, and the second image usually contains few color types. Therefore, in a case where the projection apparatus 100 uses different color gamuts (corresponding to different image modes) to simultaneously display the first image and the second image, the same color of different images provides different sensations in the vision due to the different color gamuts corresponding to the images, so that the display effect of the same color is not inconsistent, and colors of the images are not coordinated, which affects the display effect.

For example, in a case where the projection apparatus 100 displays the first image and the second image at the same time, and the color gamut of the first image is smaller than the preset color gamut in the projection apparatus 100 corresponding to the second image, the colors of the second image are more vivid and strongly stimulating to the vision due to the large preset color gamut in the projection apparatus 100, so that the same color in different regions of the displayed image has differences in vision. Especially in a case where the second image displayed by the projection apparatus 100 contains a color (e.g., red) to which the human eyes are sensitive, the displayed color is not natural.

In order to solve the above problem, a display method is provided in some embodiments of the present disclosure. The method is applied to the projection apparatus 100.

The method includes: receiving image data and outputting the image data, performing color gamut conversion on first data and not performing color gamut conversion on second data, by the first controller 11; receiving the image data output by the first controller 11 and processing the output image data to generate a driving signal, by the second controller 12, so as to drive the light valve to modulate the incident beams; and performing color gamut conversion on the second data by the second controller 12, so as to make a color gamut of a second image be same as a color gamut of a first image. The output image data includes at least one of the first data or the second data. For the first data and the second data, reference may be made to the related content described above, and details will not be repeated herein.

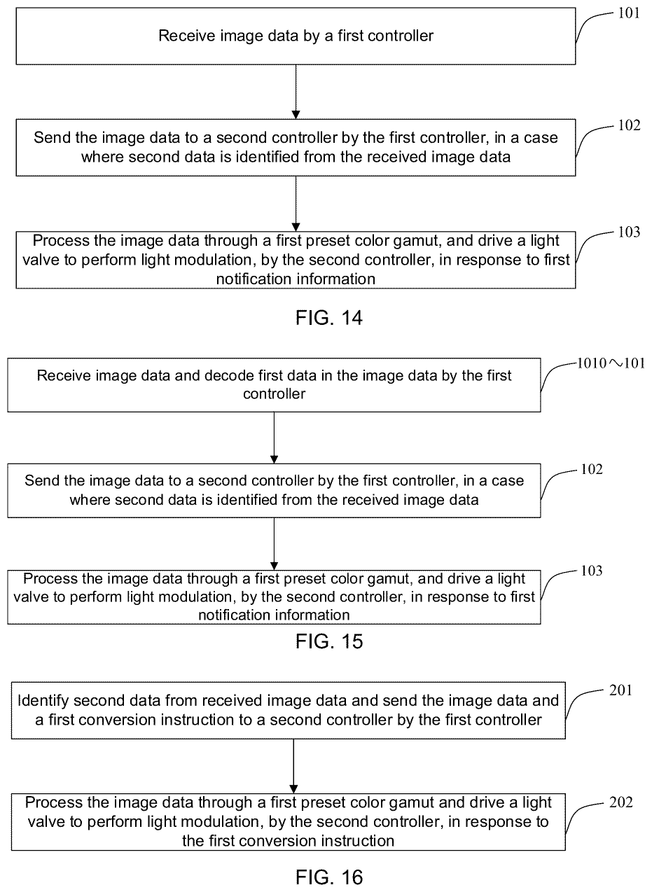

FIG. 14 is a flow chart of a display method of a projection apparatus, in accordance with some embodiments.

In some embodiments, as shown in FIG. 14, the method includes steps 101 to 103.

In step 101, image data is received by the first controller 11.

In step 102, in a case where second data is identified from the received image data, the image data is sent to the second controller 12 by the first controller 11.

The image data includes first notification information. The first notification information instructs the second controller 12 to perform color gamut conversion. Of course, in some embodiments, the first notification information may also be a separate instruction or information. For example, in a case where the first controller 11 identifies the second data from the received image data, the first controller 11 sends the image data and the first notification information to the second controller 12.

In some embodiments, the first controller 11 may identify the type (e.g., the first data or the second data) of the received image data by means of multiple manners. For example, in a case where the first data and the second data are input to the first controller 11 through a same interface, the first data has a different specific identifier than the second data, so that the first controller 11 identifies the type of the image data according to the different specific identifiers. Alternatively, in a case where the first data and the second data are input to the first controller 11 through two different interfaces, the first controller 11 determines the type of the image data according to the interface to which the image data is input.

Of course, the first controller 11 may also identify the type of the image data by other means, and the present disclosure is not limited thereto.

The first controller 11 may not convert the color gamut of the second data. Therefore, in a case where the first controller 11 identifies the second data from the image data, the first controller 11 sends the image data to the second controller 12.

In step 103, the image data is processed through the first preset color gamut, and the light valve 250 is driven to perform light modulation, by the second controller 12, in response to the first notification information.

After receiving the first notification information, the second controller 12 responds to the first notification information, uses the first preset color gamut to process the image data, and drives the light valve 250 to perform light modulation, so that the color gamut of the displayed second image satisfies the first preset color gamut. The first preset color gamut is less than or equal to the preset color gamut in the projection apparatus 100.

It will be noted that when the projection apparatus 100 displays an image, the projection apparatus 100 may automatically perform steps 101 to 103. For example, in a case where the first controller 11 identifies the second data, the first controller 11 immediately sends the image data and the first notification information to the second controller 12. The second controller 12 uses the first preset color gamut to process the image data and drives the light valve 250 to perform light modulation after receiving the image data and the first notification information.

In some embodiments, the first preset color gamut satisfies the Rec.709 standard or the DCP-P3 standard, and the preset color gamut in the projection apparatus 100 satisfies the BT2020 standard or is the own color gamut of the projection apparatus 100.

In some embodiments, the first preset color gamut may be an adjustable color gamut. For example, the first preset color gamut is adjusted according to the display performance of the projection apparatus 100, thereby improving the display effect of the projection apparatus 100.

In some embodiments of the present disclosure, colors of the second image may be close to colors of the standard color gamut (e.g., the color gamut satisfying the Rec.709 standard or the DCP-P3 standard) or to colors suitable for senses of the human eyes by using the first preset color gamut to display the second image. In this way, the problem of unnatural colors when the second image is displayed by using the preset color gamut in the projection apparatus 100 may be solved.

FIG. 15 is another flow chart of a display method of a projection apparatus, in accordance with some embodiments.

In some embodiments, as shown in FIG. 15, step 101 includes step 1010.

In step 1010, the image data is received and the first data in the image data is decoded by the first controller 11.

The first controller 11 is required to send the image data to the second controller 12 after receiving the image data, so as to make the second controller 12 process the image data as the driving signal. The second controller 12 drives the light valve 250 to perform light modulation according to the driving signal. However, the second controller 12 may not directly process the first data in the image data. Therefore, the first controller 11 is required to decode the first data in the received image data, and then send the decoded first data to the second controller 12.

For example, the first controller 11 decodes the first data in the image data into LVDS data and sends the LVDS data and the first notification information to the second controller 12 after receiving the first data in the image data.

FIG. 16 is yet another flow chart of a display method of a projection apparatus, in accordance with some embodiments.

In some embodiments, as shown in FIG. 16, the method includes steps 201 and 202.

In step 201, the second data is identified from the received image data and the image data and a first conversion instruction are sent to the second controller 12, by the first controller 11.

The first notification information includes the first conversion instruction. The first conversion instruction instructs the second controller 12 to convert the color gamut of the image to be displayed into the first preset color gamut. For example, in a case where the first controller 11 identifies the second data from the received image data, the first controller 11 generates the first conversion instruction and sends the image data and the first conversion instruction to the second controller 12.

In step 202, the image data is processed through the first preset color gamut and the light valve 250 is driven to perform light modulation, by the second controller 12, in response to the first conversion instruction.

For example, the second controller 12 uses the first preset color gamut to process the image data according to the first conversion instruction.

Of course, the method corresponding to steps 201 and 202 may also be understood as including: converting the color gamut of the second image to a color gamut of a current image mode and processing the second data by using the color gamut of the current image mode, by the second controller 12, in a case where the image data output by the first controller 11 at least includes the second data.

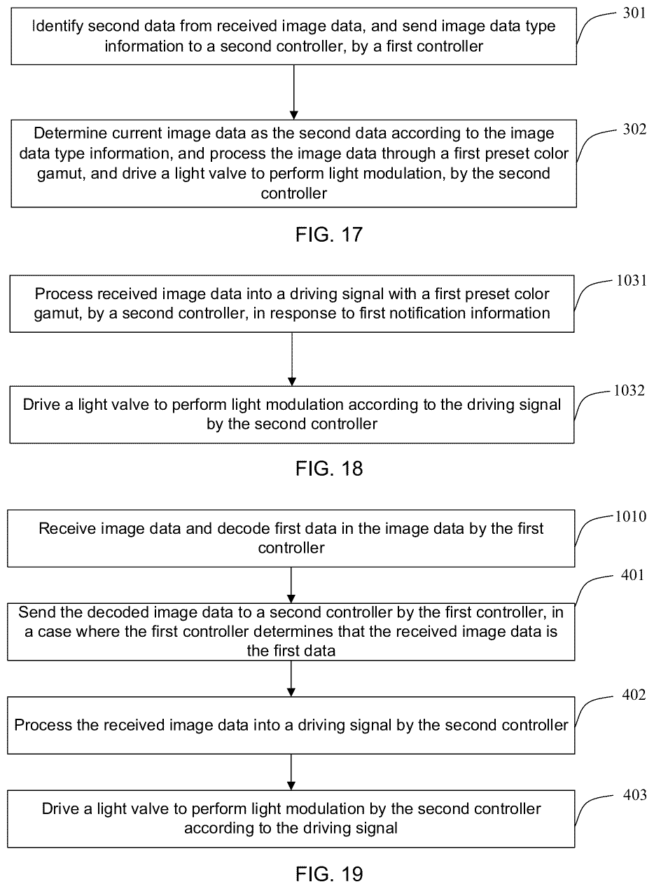

FIG. 17 is yet another flow chart of a display method of a projection apparatus, in accordance with some embodiments.

In some embodiments, as shown in FIG. 17, the method includes steps 301 and 302.

In step 301, the second data is identified from the received image data, and image data type information is sent to the second controller 12, by the first controller 11.

The first notification information includes the image data type information. The image data type information indicates that the current image data is the second data. The first controller 11 sends the image data and the image data type information to the second controller 12.

In step 302, the current image data is determined as the second data according to the image data type information, and the image data is processed through the first preset color gamut, and the light valve 250 is driven to perform light modulation, by the second controller 12.

For example, the second controller 12 determines the current image data as the second data according to the image data type information, and uses the first preset color gamut to process the image data, and drives the light valve 250 to perform light modulation, after receiving the image data and the image data type information.

Of course, the method corresponding to steps 301 and 302 may also be understood as including: processing the second data by using a color gamut of a current image mode, by the second controller 12, after it is determined that the image data output by the first controller 11 at least includes the second data.

In some embodiments of the present disclosure, in a case where the first controller 11 identifies the second data from the received image data, the first controller 11 may generate the first conversion instruction, and the second controller 12 performs the color gamut conversion according to the first conversion instruction. Alternatively, in a case where the first controller 11 identifies the second data from the received image date, the first controller 11 sends the image data type information to the second controller 12, and the second controller 12 performs the color gamut conversion after determining that the image data is the second data, and the present disclosure is not limited thereto.

FIG. 18 is yet another flow chart of a display method of a projection apparatus, in accordance with some embodiments.

In some embodiments, as shown in FIG. 18, step 103 includes steps 1031 and 1032.

In step 1031, the received image data (e.g., the second data) is processed into a driving signal through the first preset color gamut, by the second controller 12, in response to the first notification information.

The second controller 12 is required to process the received image data into the driving signal after receiving the image data sent by the first controller 11.

For example, in a case where the first controller 11 identifies the second data from the received image data, the first controller 11 sends the image data and the first notification information to the second controller 12. The second controller 12 receives the image data and the first notification information, and uses the first preset color gamut to process the received image data into the driving signal in response to the first notification information.

In step 1032, the light valve 250 is driven to perform light modulation by the second controller 12 according to the driving signal.

The second controller 12 drives the light valve 250 according to the driving signal, so that the color gamut for displaying the second image satisfies the first preset color gamut.

It will be noted that information of the first preset color gamut and rules for processing the image data may be pre-stored in the second controller 12. The information of the first preset color gamut matches the first preset color gamut, and the rules for processing the image data may be preset. For example, the information of the first preset color gamut and the rules for processing the image data are pre-stored in the second controller 12 by means of encoding. After receiving the first notification information, the second controller 12 processes the received image data into the driving signal according to the information of the first preset color gamut and the rules for processing the image data.

In some embodiments, the information of the first preset color gamut includes coordinates of red, green, and blue coordinate points of the first preset color gamut. For example, after receiving the first notification information, the second controller 12 processes the image data to obtain a corresponding driving signal according to the coordinates of red, green, and blue coordinate points of the first preset color gamut, and the mapping relationship between the first preset color gamut and the preset color gamut in the projection apparatus 100. In this way, the second image may be displayed with the same or substantially the same color gamut as the first preset color gamut, thereby solving the problem of unnatural colors when the second image is displayed.

FIG. 19 is yet another flow chart of a display method of a projection apparatus, in accordance with some embodiments.

In some embodiments, as shown in FIG. 19, after step 1010, the method further includes steps 401 to 403.

In step 401, in a case where the first controller 11 determines that the received image data is the first data, the decoded image data is sent to the second controller 12 by the first controller 11.

For example, the first controller 11 receives the first data and decodes the first data. In a case where the first controller 11 determines that the received image data is the first data, the first controller 11 completes the color gamut conversion in the process of decoding the first data. As a result, there is no need for the second controller 12 to perform the color gamut conversion. In this case, the first controller 11 sends the decoded image data (e.g., the first data) to the second controller 12.

In step 402, the received image data is processed into a driving signal by the second controller 12.

In step 403, the light valve 250 is driven to perform light modulation by the second controller 12 according to the driving signal.

The second controller 12 drives the light valve 250 to perform light modulation according to the driving signal, so that the color gamut for displaying the first image satisfies the color gamut corresponding to the current image mode of the projection apparatus 100.

The display method provided in some embodiments of the present disclosure may be applied in the startup process of the projection apparatus 100, or in the switching process of the projection apparatus 100 between the second image and the first image. During the startup process of the projection apparatus 100 or the switching process between the second image and the first image, the projection apparatus 100 using the method may automatically perform the color gamut conversion according to the type of the image data that the projection apparatus 100 identifies, so as to improve the display effect.

The following description is given by considering an example in which the second image and the first image are switched with each other by the projection apparatus 100.

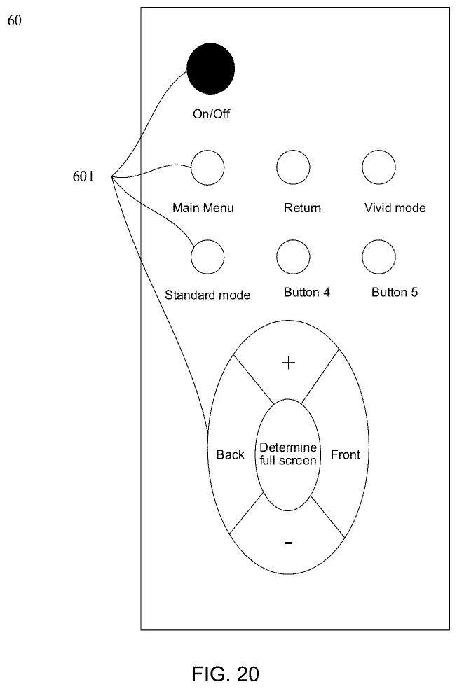

FIG. 20 is a schematic diagram of a remote control device, in accordance with some embodiments.

In some embodiments, as shown in FIG. 20, the projection system 1 further includes a remote control device 60. The remote control device 60 includes a plurality of remote control buttons 601. The plurality of remote control buttons 601 include a first button and a second button. The first button may be the “Main menu” button in FIG. 20, and the second button may be the “Determine full screen” button in FIG. 20.

The remote control device 60 sends a second exit instruction to the projection apparatus 100 after the first button is pressed. The projection apparatus 100 exits the display of the multimedia video and displays the main menu interface in full screen after receiving the instruction. The remote control device 60 sends a third exit instruction to the projection apparatus 100 after the second button is pressed. The projection apparatus 100 exits the main menu interface and displays the multimedia video in full screen after receiving the instruction.

For example, when a user is watching a multimedia video, the remote control device 60 sends the second exit instruction to the projection apparatus 100 after the user presses the first button, so as to control the projection apparatus 100 to exit the display of the multimedia video and display the main menu interface in full screen. In this case, the image data received by the first controller 11 is switched from the first data to the second data. The main menu interface may display information such as films and television programs (as shown in FIG. 12), and the user may select the films and television programs such as movies or television series through the remote control buttons 601 (e.g., the four buttons around the “Determine full screen” button in FIG. 20).

For another example, the user determines the films and television programs by pressing the second button. The remote control device 60 sends the third exit instruction to the projection apparatus 100, so as to control the projection apparatus 100 to exit the main menu interface and display the multimedia video in full screen, so that the user may watch the multimedia video. In this case, the image data received by the first controller 11 is switched from the second data to the first data.

It will be noted that the above description gives examples of the names and functions of the remote control buttons 601, and the present disclosure does not limit the functions of the projection apparatus 100 and the remote control buttons 601.

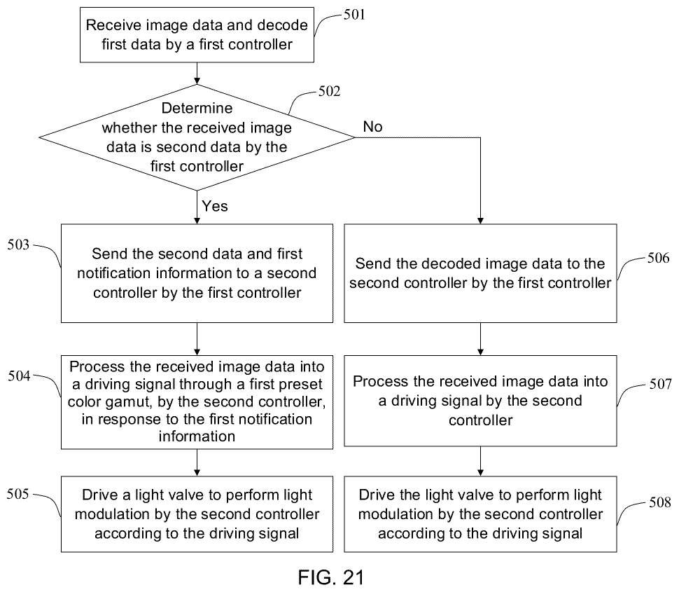

FIG. 21 is yet another flow chart of a display method of a projection apparatus, in accordance with some embodiments. FIG. 21 illustrates a color gamut conversion process when the first data and the second data are switched with each other.

In some embodiments, as shown in FIG. 21, during the process of displaying an image by the projection apparatus 100, in a case where the projection apparatus 100 is controlled to switch between the first data and the second data by the remote control device 60, the method includes steps 501 to 508.

In step 501, the image data is received and the first data is decoded by the first controller 11.

The first controller 11 receives first data and decodes the first data during the process of displaying a multimedia image (i.e., the first image) by the projection apparatus 100.

In step 502, whether the received image data is the second data is determined by the first controller 11. If so, steps 503 to 505 are performed; if not, steps 506 to 508 are performed.

For example, when the user presses the first button, the remote control device 60 sends the second exit instruction to the projection apparatus 100. The projection apparatus 100 exits the display of the multimedia video and displays the main menu interface in full screen after receiving the instruction. The image data is switched from the first data to the second data.

In step 503, the second data and the first notification information are sent to the second controller 12 by the first controller 11.

The first notification information includes the first conversion instruction or the image data type information.

In step 504, the received image data is processed into the driving signal through the first preset color gamut, by the second controller 12, in response to the first notification information.

After receiving the image data and the first notification information, the second controller 12 uses the first preset color gamut to process the received image data (e.g., the second data) into the driving signal in response to the first notification information and according to the pre-stored information of the first preset color gamut and the pre-stored rules for processing the image data.

In step 505, the light valve 250 is driven to perform light modulation by the second controller 12 according to the driving signal, so as to achieve the display of the second image.

The second controller 12 drives the light valve 250 to display the second image according to the second driving signal after completing processing the image data.

In step 506, the decoded image data (e.g., the first data) is sent to the second controller 12 by the first controller 11.

In a case where determining that the received image data is the first data, the first controller 11 performs color gamut conversion and sends the decoded image data to the second controller 12.

In step 507, the received image data is processed into the driving signal by the second controller 12.

In step 508, the light valve 250 is driven to perform light modulation by the second controller 12 according to the driving signal.

It will be noted that, during a process of displaying the second image, the remote control device 60 sends the third exit instruction to the projection apparatus 100 when the user presses the second button. The projection apparatus 100 exits the main menu interface and displays the multimedia video in full screen after receiving the instruction. In this case, the image data is switched from the second data to the first data. The process of displaying the multimedia video is similar to the process from steps 506 to 508, and the details will not be repeated herein.

The above description is mainly given by considering an example in which the remote control device 60 is used to send instructions to perform the switching between the first data and the second data. Of course, in some embodiments, the switching between the first data and the second data may also be achieved by other manners, and the present disclosure is not limited thereto.

When the projection apparatus 100 is turned on, the projection apparatus 100 first enters the main menu interface. Therefore, the projection apparatus 100 may perform the color gamut conversion during the process of turning on the projection apparatus 100, so as to make the color gamut of the second image conform to the viewing habits of human eyes. The relevant steps of switching from the second data to the first data are performed after the users select the multimedia video that they want to watch in the main menu interface, and the details will not be repeated herein.

In some embodiments, different image modes may be selected to display the second image according to requirements. Different image modes correspond to different color gamuts.

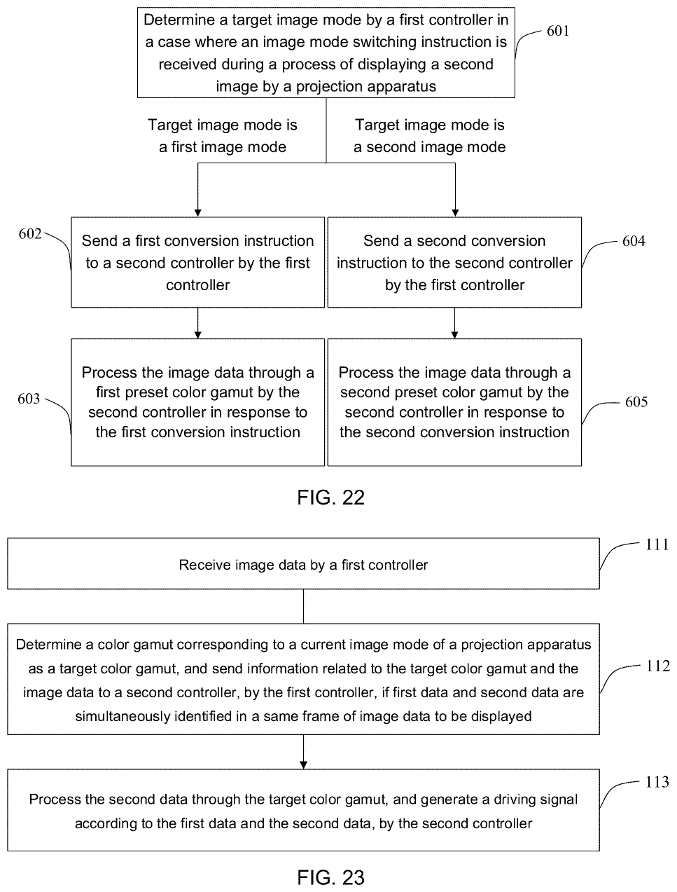

FIG. 22 is yet another flow chart of a display method of a projection apparatus, in accordance with some embodiments.

For example, as shown in FIG. 22, the method further includes steps 601 to 605.

In step 601, a target image mode is determined by the first controller 11 in a case where an image mode switching instruction is received during a process of displaying the second image by the projection apparatus 100. If the target image mode is the first image mode, steps 602 and 603 are performed; if the target image mode is the second image mode, steps 604 to 605 are performed.

The target image mode is a selected image mode. For example, during a process of displaying the second image by the projection apparatus 100, the user may send the image mode switching instruction to the first controller 11 through an external device (e.g., the remote control device 60 or a button on the projection apparatus 100), so as to control the projection apparatus 100 to display the second image in the selected image mode. The image mode switching instruction is configured to instruct the image mode to which the projection apparatus 100 is to switch.

In step 602, a first conversion instruction is sent to the second controller 12 by the first controller 11.

In a case where the first controller 11 determines that the target image mode is the first image mode, the first controller 11 sends the first conversion instruction to the second controller 12.

In step 603, the image data is processed through the first preset color gamut by the second controller 12, in response to the first conversion instruction.

For example, in a case where the first controller 11 receives the second data and determines that the target image mode is the first image mode, the first controller 11 sends the image data and the first conversion instruction to the second controller 12. The second controller 12 responds to the first conversion instruction and processes the received image data into the driving signal according to the information of the first preset color gamut and the corresponding rules for processing the image data. Afterwards, the second controller 12 drives the light valve 250 to perform light modulation according to the driving signal. For the color gamut conversion process when the first data and the second data are switched with each other, reference may be made to the above description, and details will not be repeated herein.

In step 604, a second conversion instruction is sent to the second controller 12 by the first controller 11.

In a case where the first controller 11 determines that the switched image mode is the second image mode, the first controller 11 sends the second conversion instruction to the second controller 12.

In step 605, the image data is processed through the second preset color gamut by the second controller 12, in response to the second conversion instruction.

The second conversion instruction instructs the second controller 12 to convert the color gamut of the image to be displayed into the second preset color gamut.

For example, in a case where the first controller 11 receives the second data and determines that the target image mode is the second image mode, the first controller 11 sends the image data and the second conversion instruction to the second controller 12. The second controller 12 responds to the second conversion instruction and processes the received image data into a driving signal according to the information of the second preset color gamut and the corresponding rules for processing image data. Afterwards, the second controller 12 drives the light valve 250 to perform light modulation according to the driving signal.

The information of the second preset color gamut matches the second preset color gamut. For the color gamut conversion process when the first data and the second data are switched with each other, reference may be made to the above description, and details will not be repeated herein.

It will be noted that the corresponding relationship between the image mode and the first conversion instruction and the corresponding relationship between the image mode and the second conversion instruction may be preset, and the corresponding relationships may be stored in the first controller 11. After receiving the image mode switching instruction, the first controller 11 determines the target image mode and generates a corresponding conversion instruction (e.g., the first conversion instruction or the second conversion instruction) according to the corresponding relationship between the image mode and the conversion instruction.

In some embodiments, the second preset color gamut may be the preset color gamut in the projection apparatus 100. The projection apparatus 100 uses the preset color gamut to display the second image by default. Therefore, in a case where the first controller 11 determines that the conversion instruction (e.g., the second conversion instruction) corresponds to the second preset color gamut, the second controller 12 does not convert the color gamut for displaying the second image after receiving the second conversion instruction, but may use the preset color gamut in the projection apparatus 100 to display the second image.

In some embodiments, as shown in FIG. 20, the plurality of remote control buttons 601 further includes a third button and a fourth button. The third button may be the “Vivid mode” button in FIG. 20, and the fourth button may be the “Standard mode” button in FIG. 20. The fourth button corresponds to the first image mode of the projection apparatus 100, and the third button corresponds to the second image mode of the projection apparatus 100.

For example, the color gamut corresponding to the fourth button satisfies the Rec.709 standard, and the color gamut corresponding to the third button satisfies the BT2020 standard, and the present disclosure is not limited thereto. The image mode of the projection apparatus 100 may be set by pressing the third button or the fourth button. During the process of displaying the second image, if the third button is pressed, the second preset color gamut may be selected to display the second image by the projection apparatus 100. If the fourth button is pressed, the first preset color gamut may be selected to display the second image by the projection apparatus 100.

In this way, during the process of displaying the second image, the user may select the image mode of the projection apparatus 100 to display the second image through the remote control device 60 according to the personal preference, thereby increasing the flexibility in the use of the projection apparatus 100 and meeting different use requirements of the user.

The above description is mainly given by considering an example in which the projection apparatus 100 includes the first image mode and the second image mode. Of course, in some embodiments, the projection apparatus 100 may further include other image modes, and the color gamuts corresponding to the other multiple image modes are located within the own color gamut of the projection apparatus 100, and the present disclosure is not limited thereto.

It will be noted that the first image mode and the second image mode may be applied not only to the adjustment of the color gamut of the second image, but also to the adjustment of the color gamut of the first image. Moreover, for the method of adjusting the color gamut of the first image through the first image mode or the second image mode, reference may be made to the relevant content described above, and the details will not be repeated herein.

When the projection apparatus 100 displays the second image, the colors of the second image may be made close to the colors of the standard color gamut or close to the colors suitable for the human eyes by the display method provided in some embodiments of the present disclosure. In this way, the problem of unnatural color when the second image is displayed by using the preset color gamut in the projection apparatus 100 may be solved.

A projection apparatus is further provided in some embodiments of the present disclosure, and the projection apparatus is similar in structure to the projection apparatus 100. For example, the projection apparatus includes the light valve 250, the first controller 11, and the second controller 12.

In some embodiments, the first controller 11 may be configured to: receive image data and output the image data. The output image data includes at least one of first data or second data. Moreover, the first controller may perform color gamut conversion on the first data, and may not perform color gamut conversion on the second data.

Correspondingly, the second controller 12 is configured to: receive the image data output by the first controller 11 and process the output image data to generate the driving signal, so as to drive the light valve to modulate the incident beams. The second controller 12 may perform color gamut conversion on the second data, so as to make a color gamut of a second image be same as a color gamut of a first image.

In some embodiments, the first controller 11 may be configured to: receive image data; in a case where second data is identified from the received image data, send the image data and first notification information to the second controller 12.

The image data includes at least one of first data or second data. The first data is used for displaying a first image, and the second data is used for displaying a second image. The first notification information instructs the second controller 12 to perform color gamut conversion.

Correspondingly, the second controller 12 is configured to: in response to the first notification information, process the image data by using a first preset color gamut and drive the light valve 250 to perform light modulation, so as to achieve the display of the second image.

In some embodiments, the first notification information includes a first conversion instruction. The first conversion instruction instructs the second controller 12 to convert the color gamut of the image to be displayed into the first preset color gamut.

Correspondingly, the second controller 12 may be configured to: after receiving the image data and the first conversion instruction, in response to the first conversion instruction, process the image data by using the first preset color gamut and drive the light valve 250 to perform light modulation, so as to achieve the display of the second image.

For example, in a case where the image data output by the first controller 11 at least includes the second data, the second controller 12 converts the color gamut of the second image to a color gamut of a current image mode and processes the second data by using the color gamut of the current image mode. It may be understood that since the second controller 12 uses the second preset color gamut to process the second data by default, the second controller 12 does not need to perform color gamut conversion in a case where the current image mode is the second image mode.

In some embodiments, the first notification information includes image data type information. The image data type information indicates that current image data is the second data.

Correspondingly, the second controller 12 may be configured to: after receiving the image data and the image data type information, determine that the current image data is the second data according to the image data type information, process the image data by using the first preset color gamut, and drive the light valve 250 to perform light modulation, so as to achieve the display of the second image.

For example, the second controller 12 processes the second data by using a color gamut of a current image mode after determining that the image data output by the first controller 11 at least includes the second data.

In some embodiments, the first controller may be configured to: if the received image data includes the second data, send the second data to the second controller 12.

Correspondingly, the second controller 12 may be configured to: in response to the first notification information, process the received image data into a driving signal by using the first preset color gamut; and drive the light valve 250 to perform light modulation according to the driving signal, so as to achieve the display of the second image.

In some embodiments, the first controller may be configured to: if the received image data includes first data, decode the first data and send the decoded first data to the second controller 12.

Correspondingly, the second controller 12 may be configured to: process the received image data into a driving signal; and drive the light valve 250 to perform light modulation according to the driving signal, so as to achieve the display of the first image.

In some embodiments, the first controller 11 may further be configured to: during a process of displaying the second image, in a case where an image mode switching instruction is received, if a target image mode is determined to be a first image mode according to the image mode switching instruction, send a first conversion instruction to the second controller 12; if the target image mode is determined to be the second image mode, send a second conversion instruction to the second controller 12.

The image mode switching instruction instructs the image mode to which the projection apparatus is to switch. The first conversion instruction instructs the second controller 12 to convert the color gamut of the image to be displayed into the first preset color gamut. The second conversion instruction instructs the second controller 12 to convert the color gamut of the image to be displayed into the second preset color gamut.

Correspondingly, the second controller 12 may further be configured to: in response to the first conversion instruction, process the second data by using the first preset color gamut; in response to the second conversion instruction, process the second data by using the second preset color gamut.

A color gamut corresponding to the first image mode is the first preset color gamut, and a color gamut corresponding to the second image mode is the second preset color gamut. The first preset color gamut is less than or equal to the second preset color gamut, and the second preset color gamut is the preset color gamut in the projection apparatus.

In some embodiments, the first preset color gamut satisfies any one of the Rec.709 standard and the DCI-P3 standard, and the second preset color gamut satisfies the BT2020 standard or is the own color gamut of the projection apparatus.

The contents and beneficial effects of steps performed by the projection apparatus are substantially the same as those of the display method of the projection apparatus in some embodiments described above, and details will not be repeated herein.

Generally, when the projection apparatus displays an image, the projection apparatus is required to perform color gamut conversion according to the content of the image to be displayed, so that the color gamut matches the range of the colors of the image. The projection apparatus mainly performs color gamut conversion on multimedia images. The projection apparatus does not perform color gamut conversion in the display scenarios of some non-multimedia video. For example, the projection apparatus does not perform color gamut conversion on the menu image, and the menu image is displayed through the preset color gamut in the projection apparatus. In this case, in a case where the projection apparatus displays the multimedia image and the menu image at the same time, the color gamuts of the multimedia image and the menu image are different, the colors of the image are not coordinated, and the display effect is affected.

In order to solve the above problem, a display method is further provided in some embodiments of the present disclosure. The method is applied to the projection apparatus 100.

FIG. 23 is yet another flow chart of a display method of a projection apparatus, in accordance with some embodiments.

In some embodiments, as shown in FIG. 23, the method includes steps 111 to 113.

In step 111, image data is received by the first controller 11.

It will be noted that the first controller 11 outputs image data to the second controller, the image data output by the first controller 11 includes at least one of first data or second data. For the relevant contents of the first data and the second data, reference may be made to the content described above, and details will not be repeated herein.

In step 112, by the first controller 11, if the first data and the second data are simultaneously identified in a same frame of image data to be displayed, a color gamut corresponding to the current image mode of the projection apparatus 100 is determined as a target color gamut, and information related to the target color gamut and the image data are sent to the second controller 12.

Here, the information related to the target color gamut may include the target color gamut and a display region of the second image corresponding to the second data in the image to be displayed.

In step 113, the second data is processed through the target color gamut, and the driving signal is generated according to the first data and the second data, by the second controller 12.

In this way, the second controller 12 may drive the light valve 250 to perform light modulation according to the driving signal, so that the first image and the second image may be simultaneously displayed in a same frame of an image. For the first image and the second image, reference may be made to the related content described above, and details will not be repeated herein.

During the process of projection display by the projection apparatus 100, the image mode of the projection display by the projection apparatus 100 may be set. Different image modes correspond to different color gamuts, so as to meet the viewing demands of users.

In a case where the first controller 11 simultaneously identifies the first data and the second data in a same frame of image data to be displayed, the projection apparatus 100 may simultaneously display the first image and the second image in a same displayed image. In a case where the first controller 11 identifies the first data, the first controller 11 may perform color gamut conversion on the first data and convert the color gamut for displaying first image into a color gamut corresponding to the current image mode. However, the first controller 11 may not perform color gamut conversion on the second data. Therefore, in a case where the first controller 11 simultaneously identifies the first data and the second data in a same frame of image data to be displayed, in order to make the first image and the second image have a same display effect and coordinate chromatic aberration of the displayed image, it is necessary to convert the color gamut for displaying the second image to be the same as the color gamut for display the first image.

The first controller 11 determines the color gamut corresponding to the current image mode of the projection apparatus 100 as the target color gamut, and sends the information related to the target color gamut to the second controller 12 as second notification information. Here, the corresponding relationship between the image mode and the color gamut may be preset, and the corresponding relationship may be stored in the first controller 11 for easy use. After receiving the second notification information, the second controller 12 processes the second data by using the target color gamut in response to the second notification information, so that the color gamut for displaying the second image satisfies the target color gamut. Moreover, the second controller 12 drives the light valve 250 to perform light modulation, so that the first image and the second image may be simultaneously displayed in a same frame of an image, and the color gamut for displaying the first image and the color gamut for displaying the second image are same.

In a case where the projection apparatus 100 displays the first image and the second image simultaneously, the color gamut of the second image may be converted to be the same as the color gamut of the first image by using the method, so that the color gamuts of the first image and the second image are same and the colors of the displayed image are coordinated.

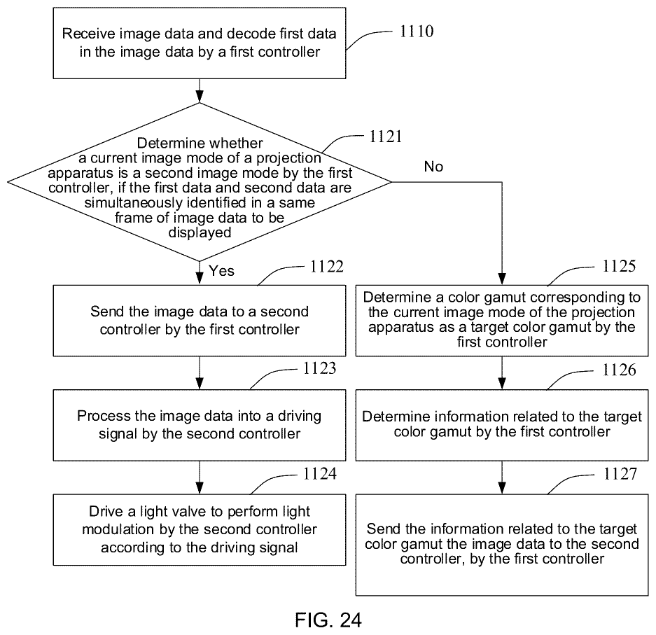

FIG. 24 is yet another flow chart of a display method of a projection apparatus, in accordance with some embodiments.

In some embodiments, as shown in FIG. 24, step 111 includes step 1110.

In step 1110, the image data is received and the first data in the image data is decoded by the first controller 11.

Since the second controller 12 may not process the image data directly, the first controller 11 is required to decode the received image data (e.g., the first data) first, and then send the decoded image data to the second controller 12.

In some embodiments, the image mode of the projection apparatus 100 includes a second image mode, and a color gamut corresponding to the second image mode is the preset color gamut in the projection apparatus 100. Therefore, in a case where the current image mode of the projection apparatus 100 is the second image mode, the first image and the second image may be displayed by using the preset color gamut in the projection apparatus 100. In this case, since the second controller 12 uses the preset color gamut in the projection apparatus 100 to process the second image by default, there is no need for the second controller 12 to convert the color gamut for displaying the second image.

For example, as shown in FIG. 24, after step 1110, the method further includes steps 1121 to 1127.

In step 1121, if the first data and the second data are simultaneously identified in a same frame of image data to be displayed, whether the current image mode of the projection apparatus 100 is the second image mode is determined by the first controller 11. If so, steps 1122 to 1124 are performed. If not, steps 1125 to 1127 are performed.

In step 1122, the image data is sent to the second controller 12 by the first controller 11.

In step 1123, the image data is processed into a driving signal by the second controller 12.

In step 1124, the light valve 250 is driven to perform light modulation by the second controller 12 according to the driving signal.

In a case where the first controller 11 determines that the current image mode of the projection apparatus 100 is the second image mode, the first image is displayed by using the preset color gamut in the projection apparatus 100. In this case, the color gamut for displaying the first image is the same as the default color gamut for displaying the second image, and there is no need to convert the color gamut for displaying the second image. Therefore, the first controller 11 sends the decoded first data and the second data to the second controller 12. After receiving the image data, the second controller 12 processes the image data into the driving signal and drives the light valve 250 to perform light modulation according to the driving signal.

In step 1125, the color gamut corresponding to the current image mode of the projection apparatus 100 is determined as the target color gamut by the first controller 11.

In a case where the first controller 11 determines that the current image mode of the projection apparatus 100 is different from the second image mode, the second controller 12 is required to convert the color gamut for displaying second image into the color gamut corresponding to the current image mode.

In step 1126, the information related to the target color gamut is determined by the first controller 11.

The information related to the target color gamut may include coordinates of vertices of the second image. Of course, the information related to the target color gamut may also include the length of the second image, the width of the second image, and coordinates of the center point of the second image, as long as the information may enable the second controller 12 to determine the position of the second image in the image to be displayed, and the present disclosure is not limited thereto.

The second image occupies a portion of the displayed image when the projection apparatus 100 displays the first image and the second image at the same time. The color gamuts of the first image and the second image may be same as long as the second controller 12 performs color gamut conversion on the second data corresponding to the second image. In this case, it is necessary to obtain the specific position of the display region of the second image in the displayed image. For example, the first controller 11 determines the coordinates of vertices of the second image after determining that the current image mode of the projection apparatus 100 is different from the second image mode, so as to determine the display region of the second image.

For example, as shown in FIG. 10, the second image is composed of a plurality of quadrilaterals (e.g., rectangles). Therefore, the display region of the second image may be calibrated by using coordinates of the vertices (e.g., vertices A, B, C, and D) of the image composed of the plurality of quadrilaterals, so as to determine the display region of the second image.

In step 1127, the information related to the target color gamut and the image data are sent to the second controller 12, by the first controller 11.

In a case where determining that the current image mode of the projection apparatus 100 is different from the second image mode, the first controller 11 determines the color gamut corresponding to the current image mode of the projection apparatus 100 as the target color gamut, and determines the information related to the target color gamut. Next, the first controller 11 sends the information related to the target color gamut together with the image data to the second controller 12. It will be noted that the image data may further include the information related to the target color gamut, or the information related to the target color gamut may further be a separate instruction or information, and the present disclosure is not limited thereto.

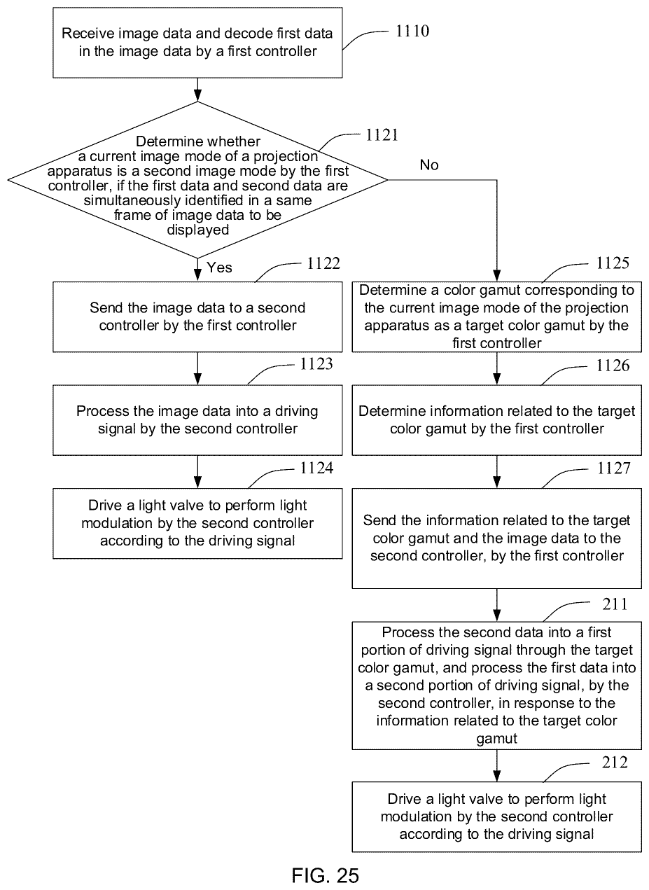

FIG. 25 is yet another flow chart of a display method of a projection apparatus, in accordance with some embodiments.

In some embodiments, as shown in FIG. 25, after step 1127, the method further includes steps 211 and 212.

In step 211, the second data is processed into a first portion of driving signal through the target color gamut, and the first data is processed into a second portion of driving signal, by the second controller 12, in response to the information related to the target color gamut.

After receiving the image data, the second controller 12 is required to process the received image data into the driving signal, so as to drive the light valve 250 to perform light modulation according to the driving signal.

In a case where the first controller 11 identifies the first data and the second data from the image data, the first controller 11 converts the color gamut of the first image corresponding to the first data into the color gamut (i.e., the target color gamut) corresponding to the current image mode of the projection image 100.

In a case where the second controller 12 receives the information related to the target color gamut and image data sent by the first controller 11, the second controller 12 uses the target color gamut to process the second data into the first portion of the driving signal, and processes the first data (i.e., the data corresponding to a region outside the second image) into the second portion of the driving signal, in response to the information related to the target color gamut.

In step 212, the light valve 250 is driven to perform light modulation by the second controller 12 according to a driving signal (i.e., the first portion of the driving signal and the second portion of the driving signal).

In this way, in a case where the second controller 12 drives the light valve 250 to perform light modulation according to the driving signal to simultaneously display the first image and the second image, the color gamuts of the first image and the second image are same.

The second data is generated by the projection apparatus 100 according to the preset color gamut in the projection apparatus 100, and thus the default color gamut for displaying the second image is the preset color gamut in the projection apparatus 100. After receiving the target color gamut, the second controller 12 may convert the color gamut for displaying the second image according to a mapping relationship between the preset color gamut in the projection apparatus 100 and the target color gamut.

In some embodiments, the target color gamut may be calibrated by coordinates of red, green, and blue coordinate points of the target color gamut. The information related to the target color gamut includes the coordinates of the red, green and blue coordinate points of the target color gamut.

For example, the preset color gamut in the projection apparatus 100 is calibrated by coordinates of the red, green and blue coordinate points corresponding to the preset color gamut in the projection apparatus 100, and the coordinates of the red, green and blue coordinate points corresponding to the preset color gamut in the projection apparatus 100 are pre-stored in the second controller 12 for easy use during color gamut conversion.

In some embodiments, the first controller 11 continues to receive the image data during the process of displaying an image by the projection apparatus 100. In this case, the situation in which the first controller 11 simultaneously identifies the first data and the second data in a same frame of image data to be displayed may include various situations.

In some examples, during the process of displaying the first image, in a case where the first controller 11 receives a first display instruction sent by a user through an external device, the first controller 11 may simultaneously identify the first data and the second data in a same frame of image data to be displayed. The first display instruction is configured to instruct the projection apparatus 100 to display the second interface.

For example, as shown in FIG. 10, the user may send the first display instruction through an external device during the process of displaying the first image, so as to find out a setting interface of system parameters. The parameter information of the projection apparatus 100 is displayed on the setting interface. In this way, the user may set parameters such as the size, resolution, luminance, contrast, and signal source of the projection image while watching the first image. In this case, the first controller 11 may simultaneously identify the first data and the second data in a same frame of image data to be displayed.

In some other examples, during the process of displaying the first image, in a case where the first controller 11 receives a second display instruction sent by the user through an external device, the first controller 11 may simultaneously identify the first data and the second data in a same frame of image data to be displayed. The second display instruction is configured to instruct the projection apparatus 100 to exit the full-screen display of the first image.

For example, as shown in FIG. 11, the user sends the second display instruction through an external device, and the first controller 11 receives the second display instruction, so that the first image exits the full-screen display. The second image may fill a blank region that appears after the first image exits the full-screen display, so as to serve as the background of the first image. In this case, the first controller 11 may simultaneously identify the first data and the second data in a same frame of image data to be displayed.

In yet some other examples, during the process of displaying the first image, in a case where the first controller 11 receives a third display instruction sent by the user through an external device, the first controller 11 may simultaneously identify the first data and the second data in a same frame of image data to be displayed. The third display instruction is configured to instruct to the projection apparatus 100 to display the first image in a form of a window.

For example, as shown in FIG. 13, the user sends the third display instruction through an external device, and the first controller 11 receives the third display instruction, so that the projection apparatus 100 previews the content of the films and television programs displaying in a form of a small window. During the preview process, users may continue to look for other programs. In this case, the first controller 11 may simultaneously identify the first data and the second data in a same frame of image data to be displayed.

It will be noted that the external device used by the user to send instructions (e.g., the first display instruction, the second display instruction, and the third display instruction) may be a remote control device 60 communicatively connected to the projection apparatus 100, a button on the projection apparatus 100, and any control device that may send instructions to instruct the projection apparatus 100 to perform corresponding operations, and the present disclosure is not limited thereto.

The following description is given by considering an example in which the first controller 11 receives the first display instruction during the process of displaying the first image.

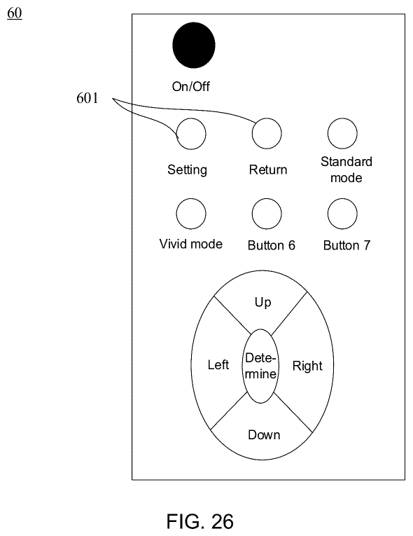

FIG. 26 is another schematic diagram of a remote control device, in accordance with some embodiments.

In some embodiments, as shown in FIG. 26, the projection system 1 further includes a remote control device 60. The remote control device 60 includes a plurality of remote control buttons 601. The plurality of remote control buttons 601 include a fifth button and a sixth button. The fifth button may be the “Setting” button in FIG. 26, and the sixth button may be the “Return” button in FIG. 26. For example, as shown in FIG. 8, in a case where the entire displayed image is the first image, the remote control device 60 may send the first display instruction to the projection apparatus 100 after the user presses the fifth button, so as to control the projection apparatus 100 to display the second image in a partial region of the displayed image.

For example, as shown in FIG. 10, the second image is displayed in a region surrounded by four vertices (i.e., the vertices A, B, C, D), and the first image is displayed outside the region surrounded by the four vertices (i.e., the vertices A, B, C, D). In this way, the user may adjust the parameters of the projection apparatus 100 while watching the films and television programs. The user presses the sixth button after completing the setting of the parameters, and thus the remote control device 60 may send a fourth display instruction to the projection apparatus 100, so as to control the projection apparatus 100 to exit the display of the second image, so that the entire displayed image is the first image. The fourth display instruction may instruct the projection apparatus 100 to exit the display of the second image, so that the entire displayed image is the first image.

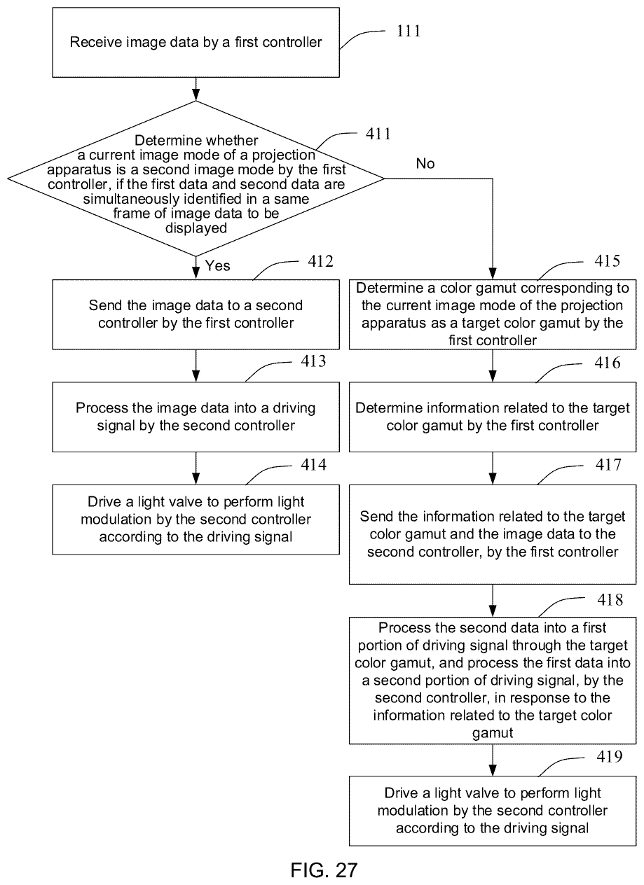

FIG. 27 is yet another flow chart of a display method of a projection apparatus, in accordance with some embodiments. FIG. 27 illustrates a process of responding to the first display instruction during the process of displaying the first image by the projection apparatus 100.

In some embodiments, the first controller 11 receives the image data during the process of the projection apparatus 100 for display. In a case where the user presses the fifth button, the remote control device 60 sends the first display instruction to the projection apparatus 100, and the first controller 11 receives the first display instruction, so that the first controller 11 may simultaneously identify the first data and the second data in a same frame of image data to be displayed. In this case, as shown in FIG. 27, the method includes steps 411 to 419.

In step 411, if the first controller 11 simultaneously identifies the first data and the second data in a same frame of image data to be displayed, whether the current image mode of the projection apparatus 100 is the second image mode is determined. If so, steps 412 to 414 are performed; if not, steps 415 to 419 are performed.

In a case where the user presses the “Setting” button of the remote control device 60 to send the first display instruction to the projection apparatus 100, the first controller 11 may receive the first display instruction, so that the first data and the second data are simultaneously identified in a same frame of image data to be displayed. In this case, the first controller 11 determines whether the current image mode of the projection apparatus 100 is the second image mode. A color gamut corresponding to the second image mode is the preset color gamut in the projection apparatus 100.

In step 412, the image data is sent to the second controller 12 by the first controller 11.

In step 413, the image data is processed into the driving signal by the second controller 12.

In step 414, the light valve 250 is driven to perform light modulation by the second controller 12 according to the driving signal.

In this way, the second controller 12 may drive the light valve 250 to perform light modulation according to the driving signal, so as to display the first image and the second image simultaneously.

In step 415, the color gamut corresponding to the current image mode of the projection apparatus 100 is determined as the target color gamut by the first controller 11.

In step 416, the information related to the target color gamut is determined by the first controller 11.

In step 417, the information related to the target color gamut and the image data are sent to the second controller 12, by the first controller 11.

In step 418, the second data is processed into the first portion of driving signal through the target color gamut, and the first data is processed into the second portion of driving signal, by the second controller 12, in response to the information related to the target color gamut.

In step 419, the light valve 250 is driven to perform light modulation by the second controller 12 according to the driving signal.

In this way, the second controller 12 may drive the light valve 250 to perform light modulation according to the driving signal, so as to display the first image and the second image simultaneously, and make the color gamuts for displaying first image and the second image same.

During the process of displaying the projection apparatus 100, after the first controller 11 receives the first display instruction, the projection apparatus 100 performs the steps (e.g., steps 411 to 419), so that the projection apparatus 100 may simultaneously display the first image and the second image in a same frame of the image, and convert the color gamut for displaying the second image into the same color gamut as the color gamut for displaying the first image, so that the colors of the displayed image are coordinated.

It will be noted that for the steps performed by the first controller 11 when receiving the second display instruction and the third display instruction, reference may be made to the steps described above, and details will not be repeated herein.

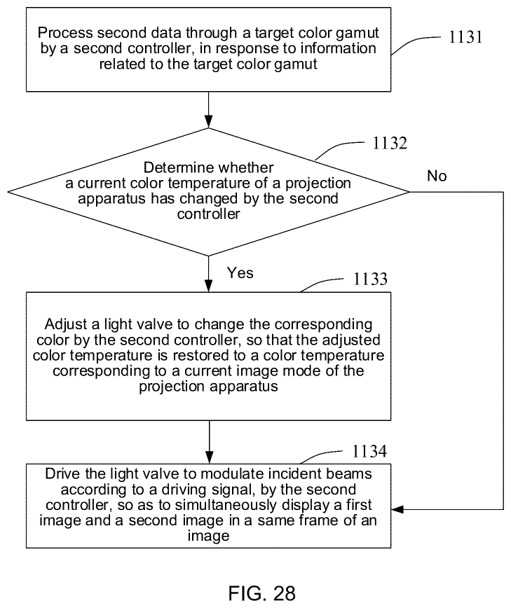

FIG. 28 is yet another flow chart of a display method of a projection apparatus, in accordance with some embodiments.

In some embodiments, as shown in FIG. 28, step 113 includes steps 1131 to 1134.

In step 1131, the second data is processed through the target color gamut by the second controller 12, in response to the information related to the target color gamut.

In step 1132, whether a current color temperature of the projection apparatus 100 has changed is determined by the second controller 12. If so, steps 1133 and 1134 are performed. If not, step 1134 is performed.

In step 1133, the light valve 250 is adjusted to change the corresponding color by the second controller 12, so that the adjusted color temperature is restored to the color temperature corresponding to the current image mode of the projection apparatus 100.

For example, the second controller 12 modulates seven colors (i.e., red, green, blue, cyan, magenta, yellow, and white) of the image to be displayed by adjusting the light valve 250. For example, the color temperature may be adjusted by adjusting the saturation and gain corresponding to each color.

In step 1134, the light valve 250 is driven to modulate incident beams according to a driving signal, by the second controller 12, so as to simultaneously display the first image and the second image in a same frame of an image.

During a process of the color gamut conversion performed by the second controller 12, the color temperature of the image currently displayed by the projection apparatus 100 may be different from the color temperature corresponding to the current image mode of the projection apparatus 100, thereby causing the anamorphosis of the colors of the displayed image. Therefore, it is necessary to adjust the color temperature of the projection apparatus 100. For example, after receiving the information related to the target color gamut, the second controller 12 processes the second data into the first portion of the driving signal through the target color gamut in response to the information related to the target color gamut, which may cause the color temperature to change. If the color temperature is not corrected, the display effect will be affected.

In some embodiments of the present disclosure, in a case where the second controller 12 determines that the current color temperature of the projection apparatus 100 has changed, the second controller 12 may adjust the light valve 250 to change the corresponding color, so that the adjusted color temperature is restored to the color temperature corresponding to the current image mode of the projection apparatus 100. Afterwards, in response to the information related to the target color gamut, the second controller 12 processes the second data into the first portion of driving signal through the target color gamut, and processes the first data into the second portion of driving signal. The second controller 12 drives the light valve 250 to perform light modulation according to the first portion of driving signal and the second portion of driving signal, thereby solving the problem that colors of the displayed image are not coordinated.

In some embodiments, the color temperatures corresponding to different image modes may be pre-stored, and the corresponding relationship between the color temperature and the color coordinates may be pre-determined. In this way, the second controller 12 may determine whether the color temperature has changed according to the change of the color coordinates when performing color gamut conversion. The color temperature correcting function may be preset in the program of the second controller 12, which is conducive to automatically running when the projection apparatus 100 performs color gamut conversion.

By the display method provided in some embodiments of the present disclosure, in a case where the projection apparatus 100 displays the first image and the second image simultaneously, the color gamut for displaying the second image may be converted into the same color gamut as the color gamut for displaying the first image, thereby solving the problem that colors of the displayed image are not coordinated.

A projection apparatus is further provided in some embodiments of the present disclosure, and the projection apparatus is similar in structure to the projection apparatuses 100. For example, the projection apparatus includes the light valve 250, the first controller 11, and the second controller 12.

In some embodiments, the first controller 11 may be configured to: receive image data; if first data and second data are simultaneously identified in a same frame of the image data to be displayed, determine a color gamut corresponding to a current image mode of the projection apparatus 100 as a target color gamut, and send the information related to the target color gamut and the image data to the second controller 12. It will be noted that the first controller uses the color gamut corresponding to the current image mode to perform color gamut conversion on the first data and does not perform color gamut conversion on the second data.

The image data output by the first controller includes at least one of the first data or the second data. The first data is used for displaying a first image, and the second data is used for displaying a second image. For the information related to the target color gamut, reference may be made to the related content described above, and details will not be repeated herein. In some embodiments, the image data sent to the second controller may further include second notification information. The second notification information may include the information related to the target color gamut.

Correspondingly, the second controller 12 may be configured to: in response to the information related to the target color gamut, process the second data by using the target color gamut, and generate a driving signal according to the first data and the second data. In this way, the second controller may drive the light valve to perform light modulation according to the driving signal, so as to simultaneously display the first image and the second image in a same frame of an image.

In some embodiments, the first controller 11 may be configured to: receive image data; decode the first data in the image data; if the first data and the second data are simultaneously identified in a same frame of image data to be displayed, and a current image mode is different from a second image mode, determine a color gamut corresponding to the current image mode as the target color gamut, determine the information related to the target color gamut, and send the information related to the target color gamut and the image data to the second controller 12; if the first data and the second data are simultaneously identified in a same frame of image data to be displayed, and the current image mode is the second image mode, send the image data to the second controller 12.

The information related to the target color gamut includes coordinates of vertices of the second image. The color gamut corresponding to the second image mode is the preset color gamut in the projection apparatus 100.

Correspondingly, the second controller 12 may further be configured to: if the current image mode is the second image mode, process the image data into a driving signal, and drive the light valve to perform light modulation according to the driving signal; if the information related to the target color gamut is received, in response to the information related to the target color gamut, process the second data into a first portion of the driving signal by using the target color gamut, process the first data into a second portion of the driving signal, and drive the light valve to perform light modulation according to the first portion of the driving signal and the second portion of the driving signal.

In some embodiments, the second controller 12 may further be configured to: in a case where the second data is processed by using the target color gamut in response to the information related to the target color gamut, if it is determined that a current color temperature has not changed, drive the light valve to perform light modulation according to the driving signal, so as to simultaneously display the first image and the second image in a same frame of an image; if it is determined that the current color temperature has changed, adjust the light valve 250 to change the corresponding color, so that the adjusted color temperature is restored to the color temperature corresponding to the current image mode, and drive the light valve 250 to perform light modulation according to the driving signal, so as to simultaneously display the first image and the second image in a same frame of an image.

In some embodiments, the image displayed by the projection apparatus 100 includes at least one of a first interface or a second interface. The first interface is a region for displaying the first image, and the second interface is a region for displaying the second image. The first controller 11 may further be configured to: in a process of displaying the first image, in a case where a first display instruction is received, simultaneously identify the first data and the second data in a same frame of image data to be displayed; in a case where a second display instruction is received, simultaneously identify the first data and the second data in a same frame image data to be displayed; in a case where a third display instruction is received, simultaneously identify the first data and the second data in a same frame image data to be displayed.

It will be noted that the first display instruction instructs the projection apparatus 100 to display the second interface, the second display instruction instructs the projection apparatus 100 to exit the full-screen display of the first image, and the third display instruction instructs the projection apparatus 100 to display the first image in a form of a window.

The contents and beneficial effects of the steps performed by the projection apparatus 100 are substantially the same as those of the display method of the projection apparatus in some embodiments described above, and details will not be repeated herein.

Some embodiments of the present disclosure provide a computer-readable storage medium (e.g., a non-transitory computer-readable storage medium), the computer-readable storage medium has stored therein computer program instructions. When the computer program instructions run on a computer, the computer program instructions make the computer execute the display method in any one of the above embodiments.

For example, the computer-readable storage medium may include, but is not limited to: a magnetic storage device (e.g., a hard disk, a floppy disk, or a magnetic tape), an optical disk (e.g., a compact disk (CD), or a digital versatile disk (DVD)), a smart card, and a flash memory device (e.g., an erasable programmable read-only memory (EPROM), a card, a stick or a key drive).

The various computer-readable storage media described in the present disclosure may represent one or more devices and/or other machine-readable storage media for storing information. The term “machine-readable storage media” may include, but are not limited to, wireless channels and various other media capable of storing, containing, and/or carrying instruction(s) and/or data.

Some embodiments of the present disclosure further provide a computer program product. The computer program product includes computer program instructions. When the computer program instructions are executed by a computer, the computer program instructions make the computer execute the display method of the laser projection apparatus in any one of the above embodiments.

Some embodiments of the present disclosure further provide a computer program. When the computer program is executed by a computer, the computer program makes the computer execute the display method of the laser projection apparatus in any one of the above embodiments.

Beneficial effects of the computer-readable storage medium, the computer program product, and the computer program are same as the beneficial effects of the display method of the laser projection apparatus in some embodiments described above, and details will not be repeated herein.

It will be noted that the steps described in a specific order in the drawings of some embodiments of the present disclosure do not require or imply that these steps must be performed in such specific order or that all the steps shown must be performed to achieve the desired results. Each step in the drawings may be appended, some steps may be omitted, multiple steps may be combined into one step for execution, or one step may be decomposed into multiple steps for execution, etc.

In the above description of the embodiments, specific features, structures, materials, or characteristics may be combined in a suitable manner in any one or more embodiments or examples.

It will be noted that any one of the technical solutions disclosed in the present disclosure may solve one or more of the technical problems described above and achieve certain disclosure purposes to a certain extent; a plurality of disclosed technical solutions may also be combined into an overall solution, so as to solve one or more of the technical problems described above and achieve certain disclosure purposes; some technical disclosures may also be selected to be combined into an overall solution, while adopting the related art and deteriorated solutions, but the deterioration trend may be compensated by means of the present technical disclosure, and one or more of the technical problems described above may be solved to a certain extent as a whole and certain disclosure purposes may be achieved to a certain extent as a whole; and the technical disclosure combined into a complete technical solution constitutes an organic and inseparable overall solution, which solves technical problems as a whole and achieves certain disclosure purposes.

Any technical disclosure in the present disclosure, as well as the recombination of the plurality of technical disclosures, may form a complete technical solution and solve one or more of the technical problems described above and achieve the disclosure purposes. They all belong to the content of the present disclosure and belong to the content that is directly and unambiguously determined according to the content of the present disclosure.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A projection apparatus, comprising:
a light valve configured to modulate incident beams according to a driving signal, so as to obtain projection beams, the projection beams being incident on a projection lens to project an image to be displayed; the image to be displayed being an entire image required to be displayed by the projection apparatus and including at least one of a first image or a second image;
a first controller configured to receive image data and output the image data; the output image data including at least one of first data or second data, the first data being used for displaying the first image, and the second data being used for displaying the second image; and
a second controller connected to the first controller and the light valve, the second controller being configured to receive the image data output by the first controller and process the output image data to generate the driving signal, so as to drive the light valve to modulate the incident beams;
wherein the first controller is further configured to perform color gamut conversion on the first data and not perform color gamut conversion on the second data; and
the second controller is further configured to perform color gamut conversion on the second data, so as to make a color gamut of the second image be same as a color gamut of the first image.

2. The projection apparatus according to claim 1, wherein
the second controller is configured to: convert the color gamut of the second image to a color gamut of a current image mode and process the second data by using the color gamut of the current image mode, in a case where the output image data at least includes the second data.

3. The projection apparatus according to claim 1, wherein
the second controller is configured to process the second data by using a color gamut of a current image mode, after it is determined that the output image data at least includes the second data.

4. The projection apparatus according to claim 1, wherein
the first controller is configured to decode the first data and send the decoded first data to the second controller, if the received image data includes the first data.

5. The projection apparatus according to claim 1, wherein
the first controller is further configured to:
during a process of displaying the second image, in a case where an image mode switching instruction is received,
send a first conversion instruction to the second controller, if it is determined that a target image mode is a first image mode according to the image mode switching instruction; the image mode switching instruction instructing an image mode to which the projection apparatus is to switch; the first conversion instruction instructing the second controller to convert a color gamut of the image to be displayed into a first preset color gamut; and
send a second conversion instruction to the second controller, if it is determined that the target image mode is a second image mode according to the image mode switching instruction; the second conversion instruction instructing the second controller to convert the color gamut of the image to be displayed into a second preset color gamut;
the second controller is further configured to:
process the second data by using the first preset color gamut, in response to the first conversion instruction; and
process the second data by using the second preset color gamut, in response to the second conversion instruction;
wherein a color gamut corresponding to the first image mode is the first preset color gamut, a color gamut corresponding to the second image mode is the second preset color gamut, the first preset color gamut is less than or equal to the second preset color gamut, and the second preset color gamut is a preset color gamut in the projection apparatus.

6. The projection apparatus according to claim 5, wherein the first preset color gamut includes one of a color gamut satisfying an Rec.709 standard and a color gamut satisfying a DCI-P3 standard, and the second preset color gamut includes a color gamut satisfying a BT2020 standard.

7. The projection apparatus according to claim 1, wherein the second data is generated by an image generator in the projection apparatus.

8. A display method of a projection apparatus, applied to the projection apparatus, the projection apparatus including: a first controller, a second controller, and a light valve; the light valve being configured to modulate incident beams according to a driving signal, so as to obtain projection beams; the projection beams being incident on a projection lens to project an image to be displayed; the image to be displayed being an entire image required to be displayed by the projection apparatus and including at least one of a first image or a second image; the second controller being connected to the first controller and the light valve; wherein the method comprises:
receiving image data and outputting the image data by the first controller; the output image data including at least one of first data or second data, the first data being used for displaying the first image, and the second data being used for displaying the second image; and
receiving the image data output by the first controller and processing the output image data to generate the driving signal, by the second controller, so as to drive the light valve to modulate the incident beams;
wherein the method further comprises:
performing color gamut conversion on the first data and not performing color gamut conversion on the second data by the first controller; and
performing color gamut conversion on the second data by the second controller, so as to make a color gamut of the second image be same as a color gamut of the first image.

9. The display method according to claim 8, wherein the performing color gamut conversion on the second data by the second controller, so as to make the color gamut of the second image be same as the color gamut of the first image, includes:
converting the color gamut of the second image to a color gamut of a current image mode and processing the second data by using the color gamut of the current image mode, by the second controller, in a case where the output image data at least includes the second data.

10. The display method according to claim 8, wherein the performing color gamut conversion on the second data by the second controller, so as to make the color gamut of the second image be same as the color gamut of the first image, includes:
processing the second data by using a color gamut of a current image mode, by the second controller, after it is determined that the output image data at least includes the second data.

11. The display method according to claim 8, further comprising:
decoding the first data and sending the decoded first data to the second controller, by the first controller, if the image data received by the first controller includes the first data.

12. The display method according to claim 8, further comprising:
during a process of displaying the second image, in a case where an image mode switching instruction is received by the first controller,
sending a first conversion instruction to the second controller, if the first controller determines that a target image mode is a first image mode according to the image mode switching instruction; processing the image data through a first preset color gamut, by the second controller, in response to the first conversion instruction; the image mode switching instruction instructing an image mode to which the projection apparatus is to switch; the first conversion instruction instructing the second controller to convert a color gamut of the image to be displayed into the first preset color gamut; and
sending a second conversion instruction to the second controller, if the first controller determines that the target image mode is a second image mode according to the image mode switching instruction; processing the image data through a second preset color gamut, by the second controller, in response to the second conversion instruction; the second conversion instruction instructing the second controller to convert the color gamut of the image to be displayed into the second preset color gamut;
wherein a color gamut corresponding to the first image mode is the first preset color gamut, a color gamut corresponding to the second image mode is the second preset color gamut, the first preset color gamut is less than or equal to the second preset color gamut, and the second preset color gamut is a preset color gamut in the projection apparatus.

13. The display method according to claim 8, further comprising: generating, by an image generator in the projection apparatus, the second data.

14. A projection apparatus, comprising:
a light valve configured to modulate incident beams according to a driving signal, so as to obtain projection beams; the projection beams being incident on a projection lens for projection imaging;
a first controller configured to perform color gamut conversion on first data by using a color gamut of a current image mode and not perform color gamut conversion on second data; and
a second controller connected to the first controller and the light valve, the second controller being configured to receive image data output by the first controller and process the output image data to generate the driving signal, so as to drive the light valve to modulate the incident beams; the image data output by the first controller including at least one of the first data or the second data, the first data being used for displaying a first image, and the second data being used for displaying a second image;
wherein the first controller is configured to:
receive image data; and
determine a color gamut corresponding to a current image mode of the projection apparatus as a target color gamut, and send information related to the target color gamut and the image data to the second controller, if the first data and the second data are simultaneously identified in a same frame of image data to be displayed;
the second controller is further configured to:
process the second data by using the target color gamut and generate the driving signal according to the first data and the second data, in response to the information related to the target color gamut.

15. The projection apparatus according to claim 14, wherein
the first controller is configured to:
decode the first data, if the received image data includes the first data;
the first controller is further configured to:
determine the color gamut corresponding to the current image mode as the target color gamut, if the first data and the second data are simultaneously identified in a same frame of image data to be displayed, and the current image mode is different from a second image mode; determine the information related to the target color gamut; and send the information related to the target color gamut and the image data to the second controller; the information related to the target color gamut including coordinates of vertices of the second image; a color gamut corresponding to the second image mode being a preset color gamut in the projection apparatus; and
send the image data to the second controller, if the first data and the second data are simultaneously identified in a same frame of image data to be displayed, and the current image mode is the second image mode;
the second controller is further configured to:
process the image data into the driving signal and drive the light valve to modulate the incident beams according to the driving signal, if the current image mode is the second image mode; and
process the second data into a first portion of driving signal, process the first data into a second portion of driving signal, and drive the light valve to modulate the incident beams according to the first portion of driving signal and the second portion of driving signal, in response to the information related to the target color gamut, if the information related to the target color gamut is received.

16. The projection apparatus according to claim 15, wherein the image mode of the projection apparatus at least includes: a first image mode and the second image mode; a color gamut corresponding to the first image mode is less than or equal to the color gamut corresponding to the second image mode; and
the color gamut corresponding to the first image mode includes one of a color gamut satisfying an Rec.709 standard and a color gamut satisfying a DCI-P3 standard, and the color gamut corresponding to the second image mode includes a color gamut satisfying a BT2020 standard.

17. The projection apparatus according to claim 14, wherein the second controller is further configured to:
in a case where the second data is processed by using the target color gamut in response to the information related to the target color gamut,
drive the light valve to modulate the incident beams according to the driving signal, if it is determined that a current color temperature has not changed; and
adjust the light valve to change a corresponding color, so as to make the adjusted color temperature be restored to a color temperature corresponding to the current image mode, and drive the light valve to modulate the incident beams according to the driving signal, if it is determined that the current color temperature has changed.

18. The projection apparatus according to claim 14, wherein the image displayed by the projection apparatus includes at least one of a first interface or a second interface, the first interface is a region for displaying the first image, the second interface is a region for displaying the second image, and the first controller is configured to:
during a process of displaying the first image,
identify simultaneously the first data and the second data in a same frame of image data to be displayed, in a case where a first display instruction is received;
identify simultaneously the first data and the second data in a same frame of image data to be displayed, in a case where a second display instruction is received; and
identify simultaneously the first data and the second data in a same frame of image data to be displayed, in a case where a third display instruction is received;
wherein the first display instruction instructs the projection apparatus to display the second interface, the second display instruction instructs the projection apparatus to exit full-screen display of the first image, and the third display instruction instructs the projection apparatus to display the first image in a form of a window.

19. A display method of a projection apparatus, the method being executed by the projection apparatus according to claim 14.

20. A non-transitory computer-readable storage medium having stored computer program instructions that, when the computer program instructions run on a computer, make the computer to execute one or more steps in the display method of the projection apparatus according to claim 8.
